(19) United States
(12) Patent Application Publication
(10) Pub. No.: US 2026/0046344 A1
(43) Pub. Date: Feb. 12, 2026

(54) DATABASE SYSTEMS AND CLIENT-SIDE METHODS FOR PAUSING FLOWS OFFLINE

(71) Applicant: Salesforce, Inc., San Francisco, CA (US)

(72) Inventors: Keye Liu, San Francisco, CA (US); Dai Duong Doan, San Francisco, CA (US)

(73) Assignee: Salesforce, Inc., San Francisco, CA (US)

(21) Appl. No.: 18/797,504

(22) Filed: Aug. 7, 2024

(51) Int. Cl. H04L 67/5683; G06F 16/25; G06F 16/27

(52) U.S. Cl. CPC H04L 67/5683; G06F 16/252; G06F 16/27

(57) ABSTRACT

Database systems and methods are provided for supporting offline operation of a process flow associated with a native application at a client device. In response to an indication to pause a flow while in an offline mode, the method captures current values for input information for one or more fields for a form associated with the flow received at a client device via one or more graphical user interface (GUI) elements of a GUI display associated with the flow, encodes the current values in a serialized format, and updates a field of an object in a data storage at the client device to include the serialized encoded values. In response to a subsequent indication to resume the flow, the method regenerates the second GUI display associated with the flow using the serialized encoded values from the field of the object to populate the one or more GUI elements.

### TECHNICAL FIELD

One or more implementations relate to the field of database systems, and more specifically, to offline operation of client-side native applications that interact with records at a database system.

### BACKGROUND

Modern software development has evolved towards web applications or cloud-based applications that provide access to data and services via the Internet or other networks. For example, social media platforms and other collaborative web sites allow users to exchange direct messages or form groups for broadcasting messages and collaborating with one another. In business environments and customer relationship management (CRM) contexts, communication platforms facilitate users sharing information about sales opportunities or other issues surrounding products or services and track changes to projects and sales opportunities by receiving broadcast updates about coworkers, files, and other project related data objects.

In contrast to traditional systems that host networked applications on dedicated server hardware, a “cloud” computing model allows applications to be provided over the network “as a service” or “on-demand” by an infrastructure provider. The infrastructure provider typically abstracts the underlying hardware and other resources used to deliver a customer-developed application so that the customer no longer needs to operate and support dedicated server hardware. Multi-tenant cloud-based architectures have been developed to support multiple user groups (also referred to as “organizations” or “tenants”) using a common hardware and software platform. Some multi-tenant database systems include an application platform that supports a customizable user experience, for example, to create custom applications, web pages, reports, tables, functions, and/or other objects or features.

In practice, it is desirable to provide mobile applications that allow users to interact with a cloud-based database system to retrieve and access data and other cloud-based services or functionality at a user's cellular phone, tablet or other mobile device. Moreover, in addition to supporting common features and functionality, in some instances, it is desirable to support more customizable user experiences with customizations that can be integrated with the mobile application, adding another layer of complexity between the cloud-based database system and the end user. However, this is further complicated by the variability or unavailability of network connections across different mobile devices operating in different geographic regions. Accordingly, it is desirable to increase potential customizations to increase productivity and improve user experiences while also accommodating offline operation to account for real-world variability in network connectivity.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 is a block diagram illustrating a computing system that includes a flow engine service associated with a native application that supports offline execution of a process flow defined by configuration metadata maintained at a database system according to some example implementations;

FIG. 2 depicts an exemplary graphical user interface (GUI) display suitable for presentation by the native application in the computing system of FIG. 1 according to some example implementations;

FIG. 3 is a block diagram illustrating an exemplary data capture junction object suitable for creation by the flow engine service in the computing system of FIG. 1 according to some example implementations;

FIG. 4 is a flow diagram illustrating an offline flow execution process suitable for implementation by the native application using the flow engine service in the computing system of FIG. 1 according to some example implementations;

FIG. 5 is a flow diagram illustrating an offline flow pausing process suitable for implementation in connection with the offline flow execution process of FIG. 4 according to some example implementations;

FIGS. 6-7 depict example data capture form GUI displays suitable for presentation by the native application in connection with the offline flow pausing process of FIG. 5 according to some example implementations;

FIG. 8 is a flow diagram illustrating an offline flow resuming process suitable for implementation in connection with the offline flow execution process of FIG. 4 according to some example implementations;

FIG. 9 is a timing diagram depicting an exemplary sequence of communications within the computing system of FIG. 1 according to some example implementations of the offline flow execution process of FIG. 4 in connection with the offline flow pausing process of FIG. 5 and the offline flow resuming process of FIG. 8;

FIG. 10A is a block diagram illustrating an electronic device according to some example implementations; and

FIG. 10B is a block diagram of a deployment environment according to some example implementations.

### DETAILED DESCRIPTION

The following description describes implementations for enabling native applications supporting customizable or user-configurable flows in an offline mode that are capable of interacting with records at a database system using a client-side service that supports create, read, update, and delete (CRUD) operations in a manner that abstracts underlying details to support both online and offline operation. In this regard, a flow generally represents an application process flow or other automated process that collects, receives or otherwise obtains data and executes or otherwise performs actions using that data to produce a corresponding result of the flow. For example, in one or more implementations, the native application is realized as a field service application that is capable of being downloaded and installed at a client mobile device (e.g., a cellular phone, a smartphone, a tablet, or the like), where the flow generally represents a form or other field service mobile flow that involves user interaction and navigation through one or more graphical user interface (GUI) displays or screens.

In exemplary implementations, the flow is realized as a form process flow that includes a sequence of GUI displays for collecting data from a client end user (e.g., a data capture form or a data collection form), which may be designed in a visual, WYSIWYG, drag and drop, declarative, and low code (or no code) manner using user-configurable web components. For example, a form flow may be visually-defined in the form of a flow chart diagram that includes elements representing actions that the flow can execute (e.g., reading or writing data, displaying information to and/or collecting data from a user, executing logic, manipulating data and/or the like) and connectors that define the available paths the flow can take at run time. Some examples of visual, low code (or no code) WYSIWYG flow design are described in U.S. Pat. Nos. 11,269,668, 11,321,422 and 11,797,638.

As described in greater detail below, to support offline operation, a client-side service downloads, to a client-side data storage, flow configuration metadata and related data records associated with the GUI displays or components thereof to be utilized for generating the sequence of GUI displays associated with the form process flow. Thereafter, in response to receiving user input or other indicia of a desire to initiate the form process flow with respect to a particular record when in an offline mode, a client-side flow engine service associated with the native application utilizes the downloaded flow configuration metadata and record data to create a junction object in the cache or other data storage at the client device for maintaining associations between user input or other data collected during execution of the form process flow and the particular record. The client-side flow engine service utilizes the downloaded flow configuration metadata and record data to generate an initial GUI display associated with the form process flow at the client device. The end user may then utilize the GUI element(s) of the GUI display to input information for one or more fields of the form corresponding to the form process flow, which in turn, may result in the client-side flow engine service creating one or more additional records object in the cache or other data storage at the client device that maintain the input information for the fields of the form associated with the record or otherwise maintain the current state or progress of the execution of the form process flow. After creating records for maintaining the user input information and flow execution state, the client-side flow engine service updates the junction object to maintain the associations between the different records associated with the respective instance of the form process flow.

When the form process flow is completed in the offline mode, the client-side flow engine service interacts with a client-side data service integrated with the native application to automatically create a corresponding form record at the database system that maintains the input information collected from the end user during execution of the form process flow. The client-side data service is configurable to support both online or offline operation of the native application, and creates a corresponding record in its associated data storage at the client-side. Thereafter, when the native application exits the offline mode or network connectivity is otherwise reestablished, the client-side data service may automatically upload and create the corresponding form record at the database system, thereby allowing the data or other input information collected from the end user while offline to be automatically uploaded and propagated back to the database system to reflect execution of the form process flow with respect to a particular record in the database system while the native application was offline.

For example, in some implementations, the client-side flow engine service associated with a field service mobile application utilizes the client-side data service to download and maintain the data capture form process flow configuration metadata and related data records from the database system to a local client-side cache that is associated with or otherwise managed by the client-side data service. Thereafter, when a user attempts to execute the data capture form process flow in an offline mode, the flow engine service uses the downloaded configuration metadata to generate the GUI displays associated with the data capture form process flow in a manner that emulates online operation without reliance on the database system or other communications network. The client-side flow engine service also utilizes the client-side data service to create records for tracking or otherwise maintaining the state of the user's progress through the various GUI displays associated with the data capture form process flow and utilizes the client-side data service to perform CRUD actions associated with the data capture form process flow with respect to downloaded instances of database records maintained in the client-side data service cache. In this regard, the flow engine service may utilize the downloaded data capture form process flow configuration metadata to create local instances of new database records with the appropriate fields, format or other structure at the client-side in the offline mode, with the client-side data service automatically generating and assigning placeholder or dummy record identification values to records created by the flow engine service in the offline mode. Additionally, the client-side data service may automatically buffer or queue various database transactions or other actions associated with the data capture form process flow when in the offline mode.

When the field service mobile application returns to an online mode, the client-side data service may automatically execute, initiate, or otherwise perform any database transactions or other actions associated with the offline execution of the data capture form process flow that were queued by the client-side data service. Additionally, the client-side data service may interact with one or more application programming interfaces (APIs) at the database system to upload or otherwise convert the local instances of new database records created at the client-side into corresponding records at the database system. In this regard, when an API or other service at the database system creates a respective instance of a record at the database system, the API or service at the database system may automatically generate and assign one or more identification values to the record in lieu of any placeholder or dummy record identification values assigned by the client-side data service. Thereafter, the client-side data service may dynamically update or otherwise synchronize the corresponding records maintained in the client-side data service cache with the database system by swapping the placeholder record identifier values with those assigned to the respective records at the database system.

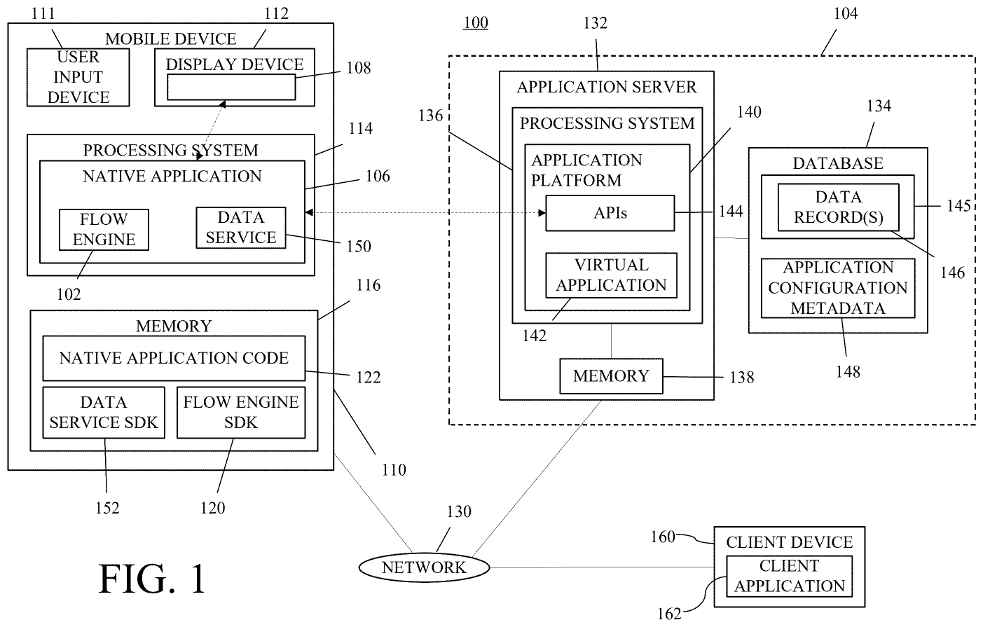

FIG. 1 depicts an exemplary computing system 100 that includes a client-side flow engine service 102 capable of supporting offline execution of customizable process flows within the context of a native application 106 executing at a client mobile device 110 using application configuration metadata 148 maintained at a database system 104 and subsequent interactions between the database system 104 and the native application 106 via a client-side data service 150. In this regard, the client-side flow engine service 102 facilitates the native application 106 generating a sequence of one or more customizable GUI displays 108 on a display device 112 of the mobile device 110 in an offline mode without reliance on a communications network 130 to retrieve the process flow configuration metadata 148 from the database system 104. It should be appreciated that FIG. 1 is a simplified representation of a computing system 100 and is not intended to be limiting. In the illustrated implementation, the database system 104 includes one or more servers 132 that users of client mobile devices 110 may interact with, over a communications network 130 (e.g., the Internet or any sort or combination of wired and/or wireless computer network, a cellular network, a mobile broadband network, a radio network, or the like), by using the native application 106 to view, access or obtain data or other information from one or more data records 146 at a database 134 or other repository associated with the database system 104.

In one or more exemplary implementations, the database system 104 includes one or more application servers 132 that support an application platform 140 capable of providing instances of virtual applications 142, over the network 130, to any number of client devices 110, 160 that users may interact with to obtain data or other information from one or more data records 146 maintained in one or more data tables 145 at the database 134 associated with the database system 104. For example, the database 134 may maintain, on behalf of a user, tenant, organization or other resource owner, data records 146 entered or created by that resource owner (or users associated therewith), files, objects or other records uploaded by the resource owner (or users associated therewith), and/or files, objects or other records automatically generated by one or more computing processes (e.g., by the server 132 based on user input or other records or files stored in the database 134). In this regard, in one or more implementations, the database system 104 is realized as an on-demand multi-tenant database system that is capable of dynamically creating and supporting virtual applications 142 based upon data from a common resource database 134 that is shared between multiple tenants, which may alternatively be referred to herein as a multi-tenant database. Data and services generated by the virtual applications 142 may be provided via the network 130 to any number of client devices, as desired, where instances of the virtual application may be suitably generated at run-time (or on-demand) using a common application platform 140 that securely provides access to the data in the database 134 for each of the various tenants subscribing to the multi-tenant system.

The application server 132 generally represents the one or more server computing devices, server computing systems or other combination of processing logic, circuitry, hardware, and/or other components configured to support remote access to data records maintained in the data tables at the database 134 via the network 130. Although not illustrated in FIG. 1, in practice, the database system 104 may include any number of application servers 132 in concert with a load balancer that manages the distribution of network traffic across different servers 132 of the database system 104.

In exemplary implementations, the application server 132 generally includes at least one processing system 136, which may be implemented using any suitable processing system and/or device, such as, for example, one or more processors, central processing units (CPUs), controllers, microprocessors, microcontrollers, processing cores, application-specific integrated circuits (ASICs) and/or other hardware computing resources configured to support the operation of the processing system described herein. Additionally, although not illustrated in FIG. 1, in practice, the application server 132 may also include one or more communications interfaces, which include any number of transmitters, receiver, transceivers, wired network interface controllers (e.g., an Ethernet adapter), wireless adapters or another suitable network interface that supports communications to/from the network 130 coupled thereto. The application server 132 also includes or otherwise accesses a data storage element 138 (or memory), and depending on the implementation, the memory 138 may be realized as a random-access memory (RAM), read-only memory (ROM), flash memory, magnetic or optical mass storage, or any other suitable non-transitory short- or long-term data storage or other computer-readable media, and/or any suitable combination thereof. In exemplary implementations, the memory 138 stores code or other computer-executable programming instructions that, when executed by the processing system 136, are configurable to cause the processing system 136 to support or otherwise facilitate the application platform 140 and the subject matter described herein.

In exemplary implementations, the code or other computer-executable programming instructions maintained in the memory 138 are executable by the processing system 136 at the application server 132 to provide one or more application programming interfaces 144 (APIs) that are configurable to allow client devices 110, 160 to interact with data records 146 or other configuration metadata 148 maintained at the database 134 via the application server 132. For example, some non-limiting examples of standard APIs 144 supported by the application platform 140 can include, but are not limited to, Simple Object Access Protocol (SOAP) API(s), representational state transfer (REST) API(s), bulk API(s), streaming API(s), Chatter REST API(s), user interface API(s), analytics REST API(s), metadata API(s), APEX® REST API(s), APEX® SOAP API(s), tooling API(s) and the like. REST and SOAP APIs are two commonly used APIs to expose data from an application platform 140 to other platforms or to allow external applications to invoke APEX® methods. For example, a REST API may support HTTP requests to access and use data to perform create, read, update, and delete (CRUD) operations concerning resources (e.g., create, read, update, and delete data records 146), which are referred to as GET, POST, PUT, and DELETE operations in REST API parlance. A SOAP API may support XML and be used to create, update, delete, retrieve (CRUD) records in any language that supports web services, and may be utilized to maintain passwords, perform searches, retrieve metadata, etc. A bulk API may be realized as a specialized REST API for loading and querying large amounts of data at once, and in some implementations, a bulk API may be asynchronous, such that a response with results can come back at some arbitrary time later (within a timeout window) after a request is submitted. A streaming API is a specialized API for setting up notifications that trigger when changes are made to data (e.g., to the values for one or more data fields of one or more data records 146) using a publish-subscribe (pub/sub) model in which clients can subscribe to channels that broadcast certain types of data changes to reduce the number of API requests and eliminate the need for polling.

In exemplary implementations, the database 134 stores or otherwise maintains data for integration with or invocation by the virtual application 142 in objects having corresponding data records 146 organized in object tables. In this regard, the database 134 may include any number of different object tables configured to store or otherwise maintain alphanumeric values or other descriptive information that define a particular instance of a respective type of object associated with a respective object table. For example, the virtual application 142 may support a number of different types of objects that may be incorporated into or otherwise depicted or manipulated by the virtual application 142, with each different type of object having a corresponding object table that includes columns or fields corresponding to the different parameters or criteria that define a particular instance of that object. In addition to standard objects that may be supported by the application platform 140 and/or the native application 106 across different resource owners, organizations or tenants, the database 134 may also store or otherwise maintain custom objects for association and/or integration with the application platform 140 and/or the native application 106. For example, an administrator user associated with a particular resource owner may utilize an instance of a virtual application 142 to create or otherwise define a new custom field to be added to or associated with a standard object, or define a new custom object type that includes one or more new custom fields associated therewith. In this regard, the database 134 may also store or otherwise maintain metadata that defines or describes the fields, process flows, workflows, formulas, business logic, structure and other database components or constructs that may be associated with a particular database object. In various implementations, the database 134 may also store or otherwise maintain validation rules providing validation criteria for one or more fields (or columns) of a particular database object type, such as, minimum and/or maximum values for a particular field, a range of allowable values for the particular field, a set of allowable values for a particular field, or the like, along with workflow rules or logical criteria associated with respective types of database object types that define actions, triggers, or other logical criteria or operations that may be performed or otherwise applied to entries in the various database object tables (e.g., in response to creation, changes, or updates to a record in an object table).

In some implementations, in addition to the metadata and rules associated with a particular type of database object, the database 134 stores or otherwise maintains application configuration metadata 148 that includes different parameters or criteria that define a particular configuration to be applied to instances of the native application 106 and/or the virtual application 142 for users associated with a particular resource owner, tenant or organization. In this regard, the application configuration metadata 148 may include values or fields that define the layout, sequencing, and other characteristics or parameters associated with one or more GUI displays 108 and/or GUI display components incorporated therein to be presented by an instance of the native application 106 executing on a mobile device 110 associated with a user affiliated with that particular resource owner. The application configuration metadata 148 may also include additional settings or configurations associated with the native application 106, as described in greater detail below. Moreover, in some implementations, the application configuration metadata 148 may define different process flows, workflows, actions, triggers, or other logical criteria or operations that may be performed or otherwise applied at the database system 104 responsive to client-side events or other indicia received from the flow engine service 102.

Still referring to FIG. 1, the mobile device 110 generally represents an electronic device coupled to the network 130 that may be utilized by a user to access a native application 106 executing on or at the mobile device 110 that supports interaction with the database system 104. In exemplary embodiments, the mobile device 110 is realized as any sort of mobile phone, cellular phone, smartphone, table or other network-enabled electronic device coupled to the network 130 that executes or otherwise supports the native application 106 that allows a user to access one or more GUI displays 108 provided by the native application 106. In exemplary implementations, the mobile device 110 includes a display device 112, such as a monitor, screen, or another conventional electronic display, capable of graphically presenting data and/or information along with a user input device 111, such as a touchscreen, a touch panel, a sensor, or the like, capable of receiving input from the user of the mobile device 110. The display device 112, the user input device 111 and other input/output interfaces associated with the mobile device 110 are coupled to a processing system 114, which may be implemented using any suitable processing system and/or device, such as, for example, one or more processors, central processing units (CPUs), controllers, microprocessors, microcontrollers, processing cores, application-specific integrated circuits (ASICs) and/or other hardware computing resources configured to support the operation of the mobile device 110 described herein. In exemplary implementations, the processing system 114 is coupled to a data storage element 116 (or memory), which may be realized as a random-access memory (RAM), read-only memory (ROM), flash memory, magnetic or optical mass storage, or any other suitable non-transitory short- or long-term data storage or other computer-readable media, and/or any suitable combination thereof.

In exemplary implementations, the memory 116 of the mobile device 110 stores code or other computer-executable programming instructions associated with the native application 106 (e.g., native application code 122) that, when executed by the processing system 114, are configurable to cause the processing system 114 to generate, support, provide or otherwise facilitate an instance of the native application 106 at the mobile device 110. In one or more implementations, the native application code 122 may be realized as a managed or distributed software package (or code package) that is published or otherwise made available to other users for installation or integration, where the software package generally includes a bundle of components that make up the native application 106 (and the functionality thereof) that may be integrated with or otherwise supported by an operating system of the mobile device 110 to interact with the database objects or other data records 146 maintained at the database system 104 independent of the application platform 140 and/or the virtual application 142. For example, the native application code 122 may be realized as one or more class files or objects within a file, folder, or other software package (e.g., a ZIP file, a file folder, or other logical container) corresponding to the instance of the native application 106 that are downloaded from the database system 104 over the network 130 and stored in the memory 116 for subsequent execution by the processing system 114.

In exemplary implementations, the memory 116 of the mobile device 110 also stores code or other computer-executable programming instructions associated with the client-side flow engine service 102 that is integrated with, invoked by or otherwise incorporated into the native application 106 (e.g., the flow engine software development kit (SDK) 120). In this regard, the flow engine SDK 120, when executed by the processing system 114, causes the processing system 114 to generate, support, provide or otherwise facilitate the flow engine service 102 and the related features, functionality, operations and/or processes described herein in connection with the instance of the native application 106 at the mobile device 110. In one or more implementations, similar to the native application code 122, the flow engine SDK 120 may be realized as a managed or distributed software package (or code package) that is published or otherwise made available to other users for installation or integration with instances of the native application 106. For example, in one implementation, an administrator associated with a resource owner may utilize a client device 160 to configure metadata 148 associated with the configuration of instances of the native application 106 associated with that resource owner to include or otherwise incorporate the flow engine SDK 120 with the native application code 122, such that when users associated with that resource owner download the software package for the native application 106, the flow engine SDK 120 is automatically included and integrated with the native application code 122 at the mobile device 110.

In exemplary implementations, the instance of the native application 106 at the mobile device 110 is configured to utilize a client-side data service 150 that supports interactions with the database system 104 and independently maintains its own associated cache of data, alternatively referred to herein as the data service cache. In a similar manner as described above, an administrator associated with a resource owner may utilize the client device 160 to modify or otherwise configure the application configuration metadata 148 to include or otherwise incorporate the data service 150, such that the code or other computer-executable programming instructions associated with the data service 150 (e.g., the data service SDK 152) is downloaded from the database system 104 to the memory 116 at the mobile device 110 to be integrated with or otherwise incorporated into the native application 106. To support the client-side data service 150, the native application 106 downloads application configuration metadata 148 that indicates the client-side data service 150 is to be utilized to retrieve data from the data records 146 maintained at the database system 104. Thereafter, based on the downloaded application configuration metadata indicating the client-side data service 150 should be utilized, the native application 106 and/or the flow engine service 102 generates or otherwise provides requests for data from the database system 104 to the client-side data service 150, such that the client-side data service 150 functions as an intermediary between the native application 106 and the database system 104. The client-side data service 150 utilizes one or more APIs 144 at the database system 104 to download record data from the data records 146 corresponding to the various components to be incorporated into the native application 106, and the client-side data service 150 utilizes the local data service cache to support sharing record data across different components that may be integrated into the native application 106 to improve efficiency and reduce complexity. Additionally, the client-side data service 150 and the corresponding data records 146 at the database system 104 (which may include application extension objects) allow for server-side control and customization of the native application 106. In one or more implementations, the client-side data service 150 is realized as the Salesforce Lightning Data Service (LDS), where the configuration of the native application 106 to utilize the client-side data service 150 is alternatively referred to herein as the LDS mode.

In various implementations, the memory 116 of the mobile device 110 also stores code or other computer-executable programming instructions associated with an application extension that is integrated with, invoked by or otherwise incorporated into the native application 106. In this regard, the application extension code, when executed by the processing system 114, causes the processing system 114 to generate, support, provide or otherwise facilitate further customization of the GUI displays 108 or other custom features, functionality, operations and/or processes to be incorporated into or integrated with the native application 106. Similar to the native application code 122 and the flow engine SDK 120, the application extension code may be downloaded from the database system 104 and installed at the mobile device 110 in connection with the download and the installation of the native application code 122 and the flow engine SDK 120. For example, in one implementation, the application extension code may be realized using an application extension object in the database 134 that stores or otherwise maintains columns or fields of values corresponding to the different parameters or criteria that customize native application 106 or the GUI displays 108 associated therewith, for example, by defining a custom GUI display component to be incorporated into a particular GUI display 108 associated with the native application 106. Similar to the application configuration metadata 148, an administrator associated with a resource owner may utilize a client device 160 to configure data records 146 for application extension objects to be associated with instances of the native application 106 associated with that resource owner, such that when users associated with that resource owner download the software package for the native application 106, the corresponding application extension code 124 embodied by the application extension objects is downloaded and automatically included and integrated with the native application code 122 at the mobile device 110. In this regard, an application extension and its associated functionality may be specific to a particular resource owner or user as a customization applied to or in addition to the underlying core functionality provided by the native application 106 and supported by the database system 104 across all users or resources owners.

The client device 160 generally represents an electronic device coupled to the network 130 that may be utilized by a user to access an instance of the virtual application 142 using an application 162 executing on or at the client device 160. In practice, the client device 160 can be realized as any sort of personal computer, mobile telephone, tablet or other network-enabled electronic device coupled to the network 130 that executes or otherwise supports a web browser or other client application 162 that allows a user to access one or more GUI displays provided by the virtual application 142. In exemplary implementations, the client device 160 includes a display device, such as a monitor, screen, or another conventional electronic display, capable of graphically presenting data and/or information along with a user input device, such as a touchscreen, a touch panel, a sensor, or the like, capable of receiving input from the user of the client device 160. The illustrated client device 160 executes or otherwise supports a client application 162 that communicates with the application platform 140 provided by the processing system 136 at the application server 132 to access an instance of the virtual application 142 using a networking protocol. In some implementations, the client application 162 is realized as a web browser or similar local client application executed by the client device 160 that contacts the application platform 140 at the application server 132 using a networking protocol, such as the hypertext transport protocol (HTTP). In this manner, in one or more implementations, the client application 162 may be utilized to access or otherwise initiate an instance of a virtual application 142 hosted by the database system 104, where the virtual application 142 provides one or more web page GUI displays within the client application 162 that include GUI elements for interfacing and/or interacting with records 146 and/or metadata 148 maintained at the database 134. In this regard, an administrator user associated with a particular resource owner may utilize the client application 162 to access an instance of the virtual application 142 to configure the data records 146 for the application extension objects to be incorporated with instances of the native application 106 for users associated with that particular resource owner as well as configuring the application configuration metadata 148 that defines, controls or otherwise customizes the GUI displays 108, the native application GUI display components and/or the functionality of the native application 106, as described in greater detail below.

In one or more implementations, the database 134 stores or otherwise maintains data records 146 for one or more database objects that may be referenced or otherwise invoked by the application configuration metadata 148 and/or the application extension objects to support incorporation of one or more configurable web components into instances of the native application 106 and/or the virtual application 142. In this regard, a configurable web component generally includes Hypertext Markup Language (HTML) code or other presentation code defining the manner in which the configured web component is to be displayed or rendered, JavaScript or other client-side executable behavioral code defining the event-driven behavior of the configured web component, and user-defined metadata including values or properties that are input or otherwise defined for various fields, parameters, variables or other attributes associated with the respective web component. In this regard, in such implementations, the application extension code downloaded to the mobile device 110 may include the HTML code and JavaScript along with other code and/or values that are executed or otherwise referenced by the processing system 114 in connection with executing the native application code 122 for the native application 106 to incorporate custom web components into the GUI displays 108 rendered by the native application 106.

In an online mode when a connection to the database system 104 over a communications network 130 is present, during execution of the native application 106, the native application 106 interacts with the data service 150 to retrieve data from the database system 104 via the APIs 144 and/or the application platform 140 to support rendering the GUI displays 108 associated with a process flow in the context of the native application 106 and support other functionality of the native application 106 in accordance with the application configuration metadata 148. In the absence of a connection to a communications network 130 or when the native application 106 is otherwise configured in an offline mode, the flow engine service 102 supports offline rendering of the GUI displays 108 associated with a process flow using the memory 116 and the data service 150 at the mobile device 110. For example, upon initialization of the native application 106, the flow engine service 102 may download or otherwise retrieve, from the database system 104 over the network 130 (e.g., via one or more APIs 144 supported by the application platform 140 at the application server 132), the respective subset(s) of application configuration metadata 148 for the process flows to be supported by the flow engine service 102 in an offline mode and record data from different data records 146 associated with the particular resource owner and/or mobile device end user that are invoked or likely to be invoked by those process flows. In this regard, the downloaded metadata and record data support the desired customizations of the GUI displays 108 generated by the flow engine service 102 without reliance on the APIs 144, the application platform 140 and/or the communications network 130.

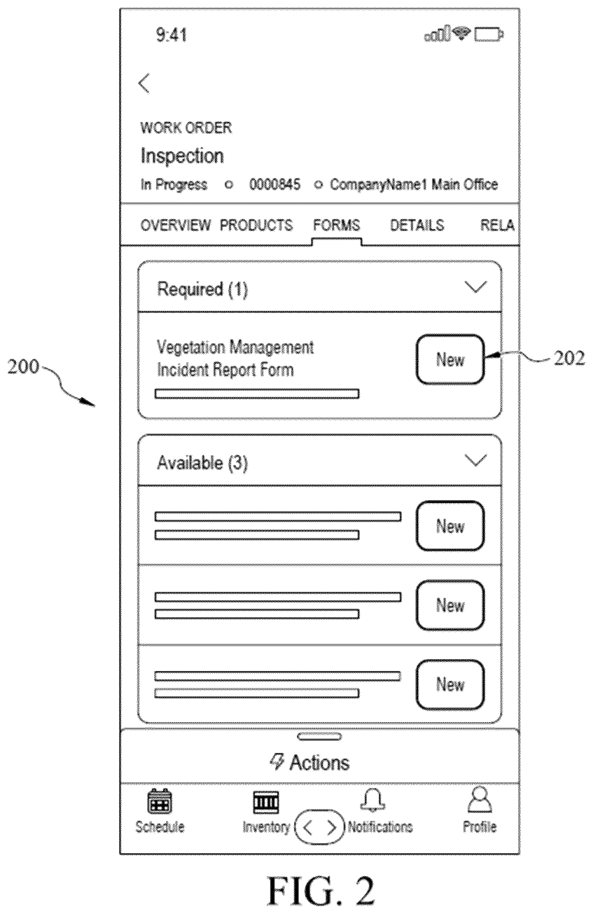

Referring to FIG. 2 with continued reference to FIG. 1, in exemplary implementations, the flow engine service 102 is configured to support offline execution of data capture form process flows that include a sequence of GUI displays 108 and corresponding text boxes, drop-down menus, picklists and/or other GUI elements for capturing or otherwise receiving data input by a user of the mobile device 110 for purposes of creating or updating one or more corresponding records 146 at the database system 104. For purposes of explanation, but without limitation, the subject matter is described herein in the context of the native application 106 being realized as a field service mobile application. In the context of a field service mobile application 106, the data capture form process flow may be configured to capture user input data for a work order associated with a service appointment. In this regard, upon initialization of the field service mobile application 106, the flow engine service 102 may download or otherwise obtain data capture form configuration metadata 148 for that resource owner that defines the customizable sequence of GUI displays 108 to be presented in connection with a data capture form for that resource owner and the corresponding customizable GUI elements for obtaining input data for a customizable set of fields for work orders, service appointments, or other field service objects associated with the resource owner.

FIG. 2 depicts an exemplary form landing page GUI display 200 suitable for presentation by field service mobile application 106 (e.g., as a GUI display 108 on the display device 112). For example, when the field service mobile application 106 launches or is otherwise initiated at the mobile device 110, the field service mobile application 106 and/or the data service 150 may automatically download record data from one or more data records 146 associated with the resource owner and/or the user of the mobile device 110, such as, for example, values for one or more fields of data associated with the data records 146 for one or more work orders, service appointments, and/or other field service objects associated with the resource owner that the user is authorized to access or is otherwise assigned to. The downloaded record data may be maintained in the local memory 116 or other data storage at the mobile device 110 (e.g., a cache associated with the processing system 114, a cache associated with the data service 150, and/or the like) for quicker reference by the field service mobile application 106. Additionally, the flow engine service 102 may download or otherwise obtain data capture form configuration metadata 148 that includes information identifying the particular type, number and/or configuration of data capture forms associated with the particular resource owner and/or the downloaded records, and additionally, in some implementations, download existing data capture form record data from corresponding data capture form data records 146 maintained at the database system 104. Thereafter, when a user manipulates or otherwise interacts with the field service mobile application 106 to navigate to the form landing page GUI display 200 (e.g., by selecting the “FORMS” tab menu element) associated with a particular field service record or object (e.g., a work order, a service appointment, or the like), the flow engine service 102 and/or the field service mobile application 106 may utilize the downloaded data capture form metadata and corresponding record data to automatically populate the form landing page GUI display 200 with information identifying the potential data capture forms configured by the resource owner for that particular field service record or object along with corresponding GUI elements for initiating or otherwise accessing a respective one of the data capture forms.

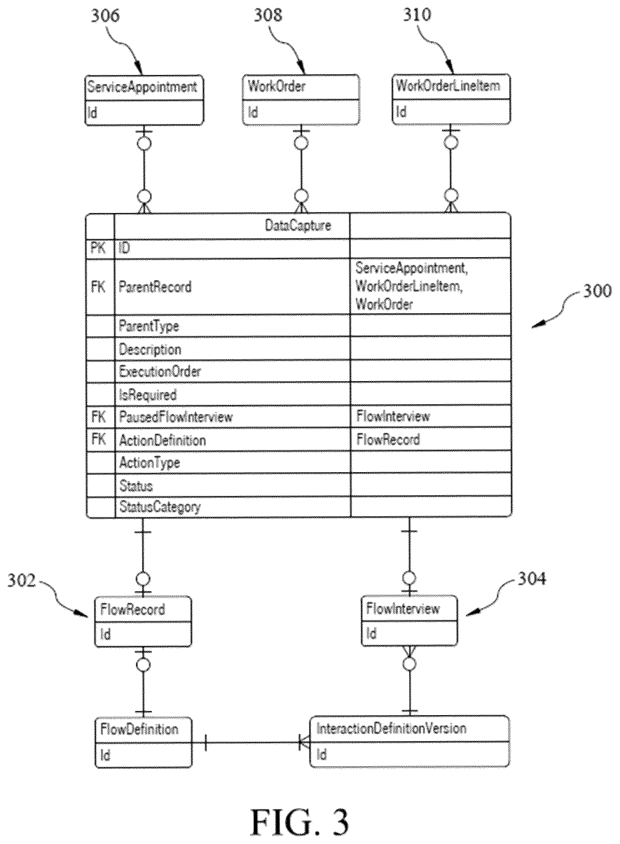

Referring now to FIG. 3 with continued reference to FIGS. 1-2, in response to user selection of a GUI element 202 to initiate a data capture form process flow, when the flow engine service 102 detects or otherwise identifies that the field service mobile application 106 is in an offline mode or a connection to the network 130 otherwise does not exist, the flow engine service 102 automatically creates a data capture junction object in a local data storage element at the mobile device 110 for maintaining an association between the particular data capture form process flow being performed and the corresponding field service record(s) associated with the data capture form. In this regard, FIG. 3 depicts an exemplary data model for a data capture junction object 300 to be created in the local data service cache at the mobile device 110 that includes data fields with corresponding identifiers or values that maintain an association between a local object 302 associated with the instance of the data capture form (e.g., FlowRecord), a local object 304 associated with the obtained or captured user input values (e.g., Flow Interview) associated with the instance of the data capture form, and one or more objects 306, 308, 310 corresponding to the parent field service records associated with the instance of the data capture form (e.g., WorkOrder, ServiceAppointment, etc.). Additionally, one or more fields of the data capture junction object 300 may store or otherwise maintain data that characterizes the current execution state or context for the instance of the data capture form process flow (e.g., Status, StatusCategory, etc.).

During subsequent execution of the selected data capture form process flow, the flow engine service 102 automatically creates and maintains one or more different data objects associated with the data capture form that track the progress of the user through the data capture form process flow while also capturing input data values or other user input events or interactions associated with the respective GUI displays 108 associated with the data capture form process flow. For example, the different GUI displays 108 associated with the data capture form process flow may be identified using the downloaded data capture form configuration metadata 148 and utilized to create different local data objects corresponding to the respective GUI displays 108 of the data capture form process flow. In this regard, the data capture form process flow may be represented as a graph data structure, where each respective GUI display 108 corresponds to a different node of the graph. Thus, for each GUI display 108 or node of the data capture form process flow traversed by the user, the flow engine service 102 may automatically create and/or update one or more local data objects that maintain data or information identifying the nodes visited or traversed by the user, the respective sequence or order in which the nodes were traversed, as well as the respective captured data values or other user inputs for the respective nodes of the data capture form process flow.

To generate the GUI displays 108 associated with the data capture form process flow in the offline mode, the flow engine service 102 utilizes the downloaded data capture form configuration metadata 148 and/or other record data previously downloaded to the mobile device 110 to automatically create web components for the respective GUI displays 108 that are configured to be incorporated into the native application 106 by the flow engine service 102 when the data capture form process flow is initiated in an offline mode. For example, for each GUI display 108, the downloaded data capture form configuration metadata 148 may be utilized to generate corresponding HTML code or other presentation code defining the manner in which the GUI display 108 (and GUI elements associated therewith) is to be displayed or rendered along with corresponding JavaScript or other client-side executable behavioral code defining the event-driven behavior of the respective GUI elements contained within that respective GUI display 108. Thus, when the data capture form process flow is executed in an offline mode, the flow engine service 102 causes the HTML code and JavaScript for the web component associated with a respective GUI display 108 to be executed or otherwise referenced by the processing system 114 in connection with executing the native application code 122 for the field service mobile application 106 to incorporate the customized data capture form GUI display screens and corresponding behaviors into the GUI displays 108 rendered by the field service mobile application 106.

In exemplary implementations, the JavaScript or other client-side executable behavioral code defining the event-driven behavior of the GUI displays 108 associated with the data capture form process flow is automatically generated or otherwise modified to utilize the client-side data service 150 in lieu of any calls or requests to the APIs 144 at the database system 104, for example, by automatically replacing any references to an API 144 for a CRUD operation identified using the data capture form configuration metadata 148 with a corresponding request or call to the client-side data service 150 for performing that CRUD operation via the client-side data service 150. As a result, any operations or actions that would otherwise be performed or triggered at the database system 104 during online mode execution of the data capture form process flow may be correspondingly performed by or at the client-side data service 150 (e.g., within the local data service cache) and the correspondingly propagated or uploaded back to the database system 104 automatically by the client-side data service 150 in response to the field service mobile application 106 returning to the online mode or a connection to the network 130 being otherwise reestablished.

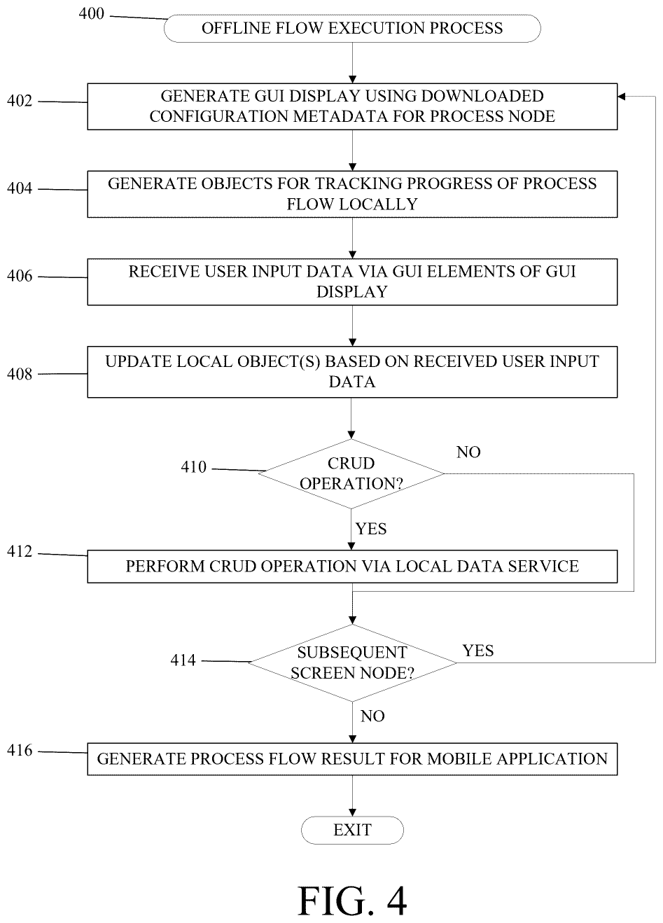

FIG. 4 depicts an exemplary offline flow execution process 400 suitable for implementation by a flow engine service associated with a native application at a mobile device to support offline operation of a process flow defined by custom metadata at a database system and perform additional tasks, functions, and/or operations described herein. For illustrative purposes, the following description may refer to elements mentioned above in connection with FIGS. 1-3. It should be appreciated that the offline flow execution process 400 may include any number of additional or alternative tasks, the tasks need not be performed in the illustrated order and/or the tasks may be performed concurrently, and/or the offline flow execution process 400 may be incorporated into a more comprehensive procedure or process having additional functionality not described in detail herein. Moreover, one or more of the tasks shown and described in the context of FIG. 4 could be omitted from a practical implementation of the offline flow execution process 400 as long as the intended overall functionality remains intact.

Referring to FIG. 4 with continued reference to FIGS. 1-3, in exemplary implementations, the offline flow execution process 400 is automatically initiated in response to a user attempting to initiate or otherwise perform a process flow associated with a mobile application when a mobile device is offline or otherwise lacks a network connection. For example, in some implementations, the native application 106 may automatically invoke the flow engine service 102 or otherwise initiate the offline flow execution process 400 in response to receiving a user input to initiate a process flow associated with the native application 106 when the native application 106 is configured in an offline mode or the mobile device 110 otherwise lacks a communications connection to the network 130. For purposes of explanation, the subject matter is described herein in the context of a server-side customizable data capture form process flow associated with an instance of a field service mobile application. That said, the subject matter described herein is not necessarily limited to any particular type of process flow or native application.

In exemplary implementations, the offline flow execution process 400 begins by automatically generating or otherwise providing a GUI display associated with an initial node or screen of the selected process flow using downloaded configuration metadata for that respective process node (task 402). For example, in one or more implementations, the field service mobile application 106 and/or the flow engine service 102 may automatically prime the mobile device 110 for offline operation of any data capture form process flows associated with the resource owner associated with the mobile device end user by utilizing the application platform 140 and/or APIs 144 at the database system 104 to automatically query and download any data capture form configuration metadata 148 for that resource owner from the database system 104 to local data storage at the mobile device 110. The data capture form configuration metadata 148 defines the sequence, layout and/or other configurable aspects of the GUI displays associated with the respective data capture form process flow and the corresponding database object types and/or data records 146 associated with the respective data capture form process flow. In this regard, in addition to downloading the data capture form configuration metadata 148, in various implementations, the field service mobile application 106 and/or the flow engine service 102 may automatically download record data from one or more data records 146 associated with a respective data capture form process flow for supporting offline operation of the data capture form process flow.

In response to user selection of a GUI element 202 associated with initiation of a data capture form process flow via a GUI display 200 of the field service mobile application 106 in an offline mode, the field service mobile application 106 may automatically invoke the flow engine service 102, which, in turn, updates the GUI display 108 by generating an initial GUI display associated with the selected data capture form process flow using the downloaded data capture form configuration metadata 148. In this regard, the initial data capture form GUI display may include text boxes or other GUI elements for receiving input data for respective data fields defined by the resource owner, with the particular layout, sequencing or other arrangement on the initial data capture form GUI display that has been predefined by the resource owner, such that the initial data capture form GUI display in the offline mode mimics or otherwise emulates execution of the data capture form process flow in an online mode. In one or more exemplary implementations, the flow engine service 102 utilizes the downloaded data capture form configuration metadata 148 and/or record data to automatically generate or otherwise create corresponding web components in the local storage at the mobile device 110 that can be executed or otherwise processed by the field service mobile application 106 to generate JavaScript Object Notation (JSON) data for the respective GUI displays and provide the desired event-driven behavior of the data capture form process flow in the offline mode.

Still referring to FIGS. 1-4, the offline flow execution process 400 continues by automatically generating one or more objects for tracking progress of the data capture form process flow in local storage at the mobile device, receiving input information from the user for one or more of the fields of the data capture form defined for the respective data capture form GUI display via the respective GUI elements of the data capture form GUI display, and automatically updating one or more of the local objects using the received user input information to reflect the user's progress with respect to the data capture form process flow (tasks 404, 406, 408). For example, as described above in the context of FIG. 3, in exemplary implementations, the flow engine service 102 automatically creates a data capture junction object 300 for maintaining an association between the respective instance of data capture form being interacted with by the user, the particular field service data records associated with the respective instance of data capture form (e.g., the particular work order data record, the particular service appointment record, and/or the like) and additional objects generated locally by the flow engine service 102 for tracking the user's progress within the data capture form, that is, the current execution state or context for the instance of the data capture form process flow. In response to receiving values or other data or information from the user via a respective GUI element of the GUI display, the flow engine service 102 may automatically update the local objects to include the input values for the respective data fields associated with the respective GUI display and the corresponding state of the respective GUI display (e.g., updating the status to in progress, identifying the GUI elements that have been interacted with and the corresponding input states or values associated with the GUI elements, and/or the like).

Referring to FIG. 4, in one or more exemplary implementations, the offline flow execution process 400 detects, identifies or otherwise determines whether a CRUD operation is to be performed in response to a particular user input or other event within the context of the respective GUI display of the data capture form process flow, and in response to detecting a CRUD operation event, automatically initiates or otherwise performs the CRUD operation via the local data service (tasks 410, 412). In this regard, when a particular user input or other event associated with a GUI element of a respective data capture form GUI display would trigger a CRUD operation at the database system 104, when in the offline mode, the flow engine service 102 is configurable to automatically initiate or otherwise perform the CRUD operation via the local data service 150. For example, the JavaScript or other executable code associated with the web component for a respective GUI element of a respective data capture form GUI display may be configurable to cause the flow engine service 102 to automatically generate a CRUD request (e.g., a POST request, a GET request, etc.) in an appropriate input format for the local data service 150 and provide the request to the data service 150. The data service 150 may then automatically update and/or retrieve values for one or more fields of record data in the cache associated with the data service 150 to effectively emulate or mimic online operation of the field service mobile application 106 that would otherwise use the application platform 140 and/or the APIs 144 to perform the CRUD operation.

For example, in one implementation, selection of a GUI element indicating the completion of a particular data capture form GUI display may be configured to trigger creation of a data record 146 for a particular type of field service object or other CRM object via an API 144 during online operation. To support offline operation, the JavaScript or other executable code associated with the web component for the respective GUI element indicating completion of the respective data capture form GUI display may correspondingly cause the flow engine service 102 to provide a request to the data service 150 to create a record for that particular type of object using at least some of the user input values received via the GUI elements of that respective data capture form GUI display. In response, the data service 150 automatically creates in its associated cache or other local data storage at the mobile device 110, a respective instance of that record having the user input values. Additionally, the flow engine service 102 may automatically update the data capture junction object 300 to maintain an association between the new record created at the data service 150 and the respective instance of the data capture form process flow.

Still referring to FIG. 4, in response to receiving a user input to a GUI element that indicates that the user has completed the respective process flow node or would otherwise like to progress from the current GUI display, the offline flow execution process 400 detects, identifies or otherwise determines whether the next or subsequent node of the process flow corresponds to a screen node having a respective GUI display associated therewith (task 414). For example, after completing a respective data capture form GUI display, the user may select a button or similar GUI element to advance to the next process node of the data capture form process flow. In response to identifying the subsequent node of the process flow corresponds to a screen node, the offline flow execution process 400 repeats the loop defined by tasks 402, 404, 406, 408, 410 and 412 to dynamically update the GUI display at the mobile device to the next GUI display of the data capture form process flow. In this regard, after updating the local objects to maintain the received user input values for the respective data fields of the respective data capture form GUI display and to reflect the current state or progress for that respective data capture form GUI display as completed, the flow engine service 102 utilizes the downloaded data capture form configuration metadata 148 to automatically generate the next GUI display of the selected data capture form process flow for receiving user input information for additional data fields. Thereafter, the flow engine service 102 correspondingly updates the data capture junction object 300 and/or other local objects to reflect the current state of the data capture form process flow as the user progresses through the respective data capture form GUI displays. In this manner, in the offline mode, the flow engine service 102 effectively logs or otherwise captures the user interactions within the context of the respective data capture form process flow to enable navigation between GUI displays of the data capture form process flow while concurrently capturing and maintaining the values, data or other information input by the user via the respective data capture form GUI displays.

After traversing or otherwise progressing through the various nodes of the process flow, the offline flow execution process 400 automatically generates or otherwise constructs a process flow result for the mobile application and provides the process flow result back to the mobile application for subsequent handling and/or processing (task 416). In this regard, the flow engine service 102 may automatically generate JSON data provided back to the field service mobile application 106 for updating the form landing page GUI display 200 to reflect completion of the particular data capture form process flow using one or more of the data capture junction object 300 and/or the other local objects for tracking progress of the data capture form process flow.

Still referring to FIGS. 1-4, in response to exiting the offline mode, the data service 150 is configured to automatically update the database 134 at the database system 104 to reflect the user's interaction with respect to the respective data capture form process flow. For example, the data service 150 may automatically generate a request for a CRUD operation provided to an API 144 at the database system 104 to create, modify or otherwise update a data record 146 for a field service object or other CRM object that was created during offline execution of the data capture form process flow. In this regard, in some implementations, a button or similar GUI element associated with the completion of the data capture form may be configurable to cause the flow engine service 102 to provide a request to the data service 150 to create a form record corresponding to the instance of the data capture form process flow, such that the data service 150 automatically creates a corresponding form record 146 at the database system 104 that is associated with the field service object or other CRM object for which the data capture form was performed (e.g., by using the data capture junction object 300 to associate the form record with the appropriate work order, service appointment, and/or the like). In other implementations, the flow engine service 102 may be configurable to create and maintain the data capture junction object 300 at the mobile device 110 via the data service 150, such that the data service 150 automatically uploads the data capture junction object 300 to the database system 104 via an API 144 associated with the application platform 140. In such implementations, the application platform 140 and/or the API 144 is configured to automatically translate or otherwise convert the data capture junction object 300 into a corresponding data capture form record 146 in the database 134. Additionally, the data capture junction object 300 may be utilized to automatically populate one or more fields of the form record 146 to maintain the desired association with the respective work order record 146, the respective service appointment record 146 and/or one or more other records 146 for the field service object(s) and/or CRM object(s) associated with the respective instance of the data capture form.

For example, the application platform 140 and/or the API 144 may utilize the data capture junction object 300 to create a new data capture form record 146 in the database 134 having the desired parent-child relationships between other field services records 146 in the database 134 corresponding to the respective local objects 306, 308, 310 (e.g., the parent WorkOrder, ServiceAppointment and/or the like) with field values populated with user input data or other values from the local objects 302, 304 utilized to track the user's progress within the form. Additionally, the application platform 140 and/or the API 144 may automatically assign or otherwise swap and replace any placeholder identification values assigned by the client-side data service 150 with an updated record identification value assigned to the data capture form record 146 by the application platform 140 and/or the API 144. In this regard, the resulting form record 146 created at the database system 104 includes the values, data or other input information received from the user during offline execution of the data capture form process flow along with other state information pertaining to the user's progress or other interaction with the respective instance of the data capture form process flow.

By virtue of the offline flow execution process 400, the flow engine service 102 may utilize the downloaded data capture form configuration metadata 148 and the client-side data service 150 to support offline execution of a data capture form process flow in a manner that reflects the desired customizations defined by a resource owner or other server-side controls without reliance on a communications network 130. For example, a field service technician user of a field service mobile application 106 may initiate and progress through a data capture form process flow to input information for a data capture form defined by a particular resource owner associated with that field technician user to capture data pertaining to a particular service appointment, work order, and/or the like while in a remote area having intermittent and/or nonexistent connectivity to the communications network 130, with CRUD operations associated with the data capture form (e.g., to create, modify and/or update the service appointment, work order, and/or other field service object data records 146 in the database 134) being performed locally via the data service 150 and the respective cache or local storage associated with the data service 150. In this manner, the behavior of the field service mobile application 106 with respect to execution of the data capture form process flow and the corresponding user experience may be substantially the same as in an online mode, such that the offline nature of the data capture form process flow may be imperceptible to the field service technician. Thereafter, when a connection to the communications network 130 is reestablished or the field service mobile application 106 otherwise returns to an online mode, the client-side data service 150 may automatically synchronize its local cache to the database 134 at the database system 104 to correspondingly reflect the desired CRUD operations associated with the offline execution of the data capture form process flow. In this manner, the database system 104 is automatically updated to reflect the offline execution of the data capture form process flow without requiring any additional user interaction.

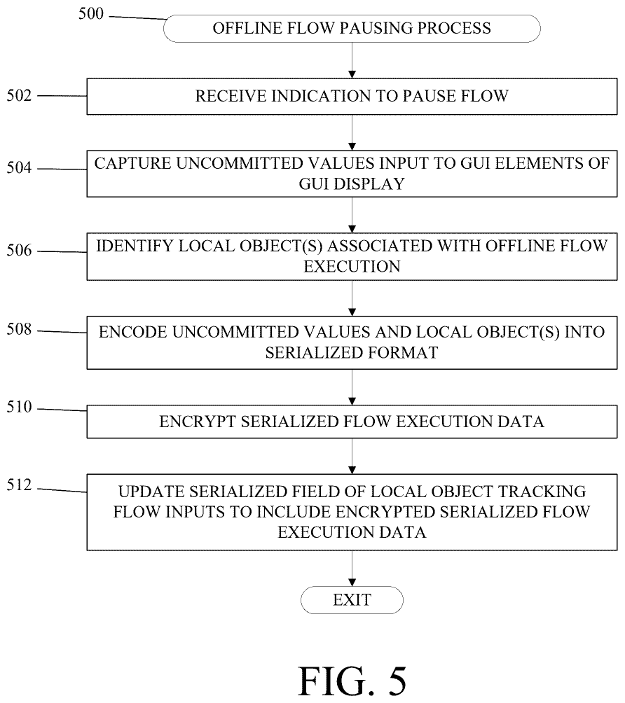

Referring now to FIGS. 5-8, in practice, a field service technician or other user may multitask during the course of a service appointment or otherwise switch between work orders or other tasks while offline. Accordingly, exemplary implementations described herein allow a user of a field service mobile application 106 to save their work in progress during offline execution of a data capture form process flow in a manner that allows the user to return to that particular data capture form process flow at a later point in time to resume offline execution of the data capture form process flow without having to start over or otherwise reinitiate the data capture form process flow.

FIG. 5 depicts an exemplary offline flow pausing process 500 suitable for implementation by a flow engine service associated with a native application at a mobile device to support pausing and saving the current state of a process flow defined by custom metadata at a database system during offline execution and perform additional tasks, functions, and/or operations described herein. For illustrative purposes, the following description may refer to elements mentioned above in connection with FIGS. 1-4. It should be appreciated that the offline flow pausing process 500 may include any number of additional or alternative tasks, the tasks need not be performed in the illustrated order and/or the tasks may be performed concurrently, and/or the offline flow pausing process 500 may be incorporated into a more comprehensive procedure or process having additional functionality not described in detail herein. Moreover, one or more of the tasks shown and described in the context of FIG. 5 could be omitted from a practical implementation of the offline flow pausing process 500 as long as the intended overall functionality remains intact.

Referring to FIG. 5, with continued reference to FIGS. 1-4, in exemplary implementations, the offline flow pausing process 500 is implemented or otherwise performed in connection with the offline flow execution process 400 in response to identifying or otherwise receiving one or more indicia to pause execution of the flow currently being executed offline (task 502). For example, in some implementations, the flow engine service 102 associated with the field service mobile application 106 may automatically generate or otherwise provide a selectable GUI element on, within or otherwise in connection with a respective data capture form GUI display that is selectable or otherwise manipulable by a user to provide indication of a desire to pause progress or otherwise preserve the state of the flow, for example, to return to a landing page GUI display associated with the field service mobile application 106, to initiate a different flow, and/or the like. In yet other implementations, the flow engine service 102 may incorporate a timer or other similar features or logic to automatically identify execution of the flow should be paused due to inactivity that exceeds a threshold duration of time. In yet other implementations, the flow engine service 102 may be configured to automatically pause execution of the flow when the user closes the field service mobile application 106 or otherwise navigates away from the field service mobile application 106.

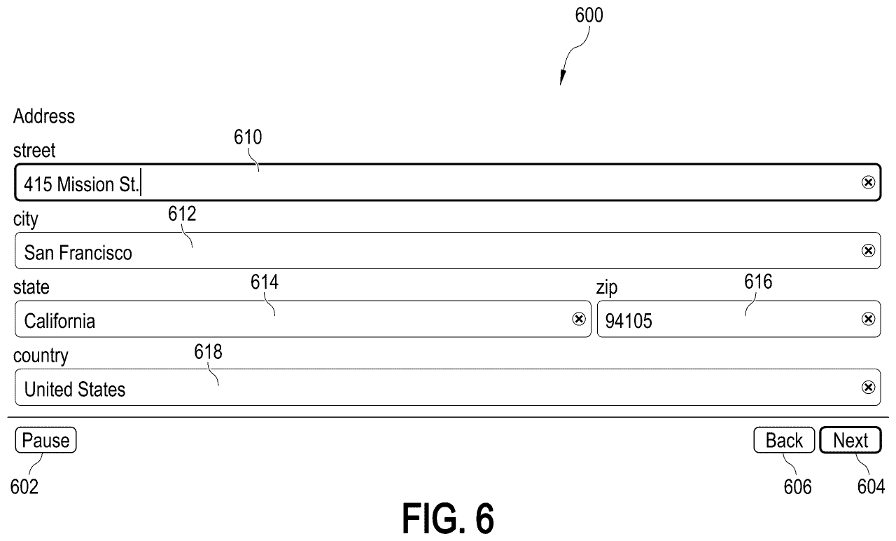

FIG. 6 depicts an exemplary data capture form GUI display 600 that includes a button 602 or similar selectable GUI element manipulable by a user to trigger execution of the offline flow pausing process 500 during offline execution of a data capture form process flow. As described above, the data capture form GUI display 600 also includes GUI elements 610, 612, 614, 616, 618 (e.g., text boxes, drop-down menus, picklists and/or other GUI elements) for capturing or otherwise receiving user input values for creating or updating a record along with buttons or similar selectable GUI elements 604, 606 for navigating the sequence of GUI displays associated with the data capture form. In exemplary implementations, in response to user selection of the pause button 602, the offline flow pausing process 500 is initiated to automatically capture or otherwise maintain the current state of execution of the data capture form process flow including the current state of the GUI elements 610, 612, 614, 616, 618 and user input values associated therewith.

Referring again to FIG. 5, in response to an indication to pause offline execution of a flow, the offline flow pausing process 500 continues by capturing, recording or otherwise obtaining the uncommitted values corresponding to the input information received from the user within the context of the current presented GUI display and maintaining an association between the uncommitted input values and the respective GUI elements of the GUI display (task 504). In this regard, the flow engine service 102 utilizes the JSON data associated with the currently presented data capture form GUI display to establish and maintain a mapping between the current input values or other current state information associated with the respective GUI elements on the currently presented data capture form GUI display and those GUI elements. For example, a respective user input value obtained via a respective GUI element may be tagged or otherwise marked up with an identifier associated with the respective GUI element to maintain an association between the GUI element and the respective value or state of the GUI element at the time of pausing.

In addition to capturing the uncommitted values input to the GUI elements of the currently presented GUI display, the offline flow pausing process 500 also identifies or otherwise obtains the local object(s) associated with the offline execution of the current flow (task 506). As described above in the context of FIGS. 3-4, in exemplary implementations, the flow engine service 102 automatically creates local objects for tracking the user's progress within the data capture form including indication of the respective GUI displays that have been previously traversed, the GUI elements that have been interacted within the respective GUI displays, the corresponding input states or values associated with those GUI elements, and/or the like. For example, the flow engine service 102 may create local JavaScript objects for tracking the user's interactions with the offline flow, such as, for example, one or more journal objects that maintain data or information identifying the nodes of the data capture form process flow that were visited or traversed by the user, the respective sequence or order in which the nodes were traversed, the respective captured data values or other user inputs for the respective nodes of the data capture form process flow for those traversed nodes, along with one or more interview state objects that maintain the latest key-value pairs of user inputs and flow variables from preceding nodes of the data capture form process flow.

After capturing the current uncommitted values from the currently presented GUI display of the flow along with the other local objects for the flow, the offline flow pausing process 500 continues by automatically encoding or otherwise converting the local data representing the current state of offline execution of the flow into a serialized format (task 508). In this regard, the flow engine service 102 performs a serialization process to convert the key-value pairs of uncommitted user input values and associated GUI elements into a serialized format while also serializing the key-value pairs of committed user input values and associated GUI elements from other GUI displays or nodes previously traversed by the user along with information characterizing the sequence of interactions with the data capture form process flow. In this regard, the various local objects and other JSON data supporting offline execution of the data capture form process flow may be converted into a serialized representation for storing, which may alternatively be referred to herein as the serialized flow execution data.

For example, the JSON data representation of the offline flow execution data including the key-value pairs of uncommitted user input values and associated GUI elements for the uncommitted values from the currently presented GUI display of the flow and other local uncommitted values from the currently presented GUI display of the flow and other local JavaScript objects may be realized as:
‘{“_currentNodeName”:“screen”,“_isCurrentNodeInteractive”:false,“_pausedFlowInterviewId”:“__undefined_”,“_interviewJournalList”:[{“_timestamp”:“2024-07-26T22:35:22.606Z”,“_currentNodeName”:“_0”,“_changedValueMap”:{“_map__”:[[“parentObjectType”,{“_value”:[ ],“_isCollection”:false,“_dataType”:“STRING”,“_label”:“_undefined__”}],[“parentRecordId”,{“_value”:[ ],“_isCollection”:false,“_dataType”:“STRING”,“_label”:“__undefined__”}],[“recordId”,{“_value”:[ ], “_isCollection”:false,“_dataType”:“STRING”,“_label”:“_undefined_”}]]},“_journalItemType”:“START”,“_message”:“ ”,“_userId”:“005xx000001X7QL”,“_isCurrentNodeInteractive”:false}],“_locationStack”:[{“_journalItemType”:“START”,“_currentNodeName”:“_0”,“_isNodeInteractive”:false,“_changedValueMap”:{“__map_”:[[“parentObjectType”,{“_value”:[ ],“_isCollection”:false,“_dataType”:“STRING”,“_label”:“_undefined__”}],[“parentRecordId”,{“_value”:[ ],“_isCollection”:false,“_dataType”:“STRING”,“_label”:“_undefined_”}],[“recordId”,{“_value”:[ ],“_isCollection”:false,“_dataType”:“STRING”,“_label”:“_undefined__”}]]}}],“_interviewState”:{“_uncommittedValueMap”:{“_map_”:[[“shorttext”,{” _value”:[{“_map_”:[[“value”,{“_value”:[“Here is some value”],“_isCollection”:false,“_dataType”:“STRING”,“_label”:“_undefined_”}]]}}],“_isCollection”:false,“_dataType”:“LIGHTNING_COMPONENT_OUTPUT”,“label”:“_undefined_”}]]},“_valueMap”:{“_map_”:[[“parentObjectType”, {“_value”:[ ],“_isCollection”:false,“_dataType”:“STRING”,“_label”:“__undefined_”}],[“parentRecordId”,{“_value”:[ ],“_isCollection”:false,“_dataType”:“STRING”,“_label”:“_undefined_”}],[“recordId”,{“_value”:[ ],“_isCollection”:false,“_dataType”:“STRING”,“_label”:“_undefined__”}]]},“_element2HistoryMap”:{“_map__”:[[“_0”,{“_map__”:[[“parentObjectType”,{“_value”:[ ],“_isCollection”:false,“_dataType”:“STRING”,“_label”:“__undefined_”}],[“parentRecordId”,{“_value”:[ ],“_isCollection”:false,“_dataType”:“STRING”,“_label”:“_undefined_”}], [“recordId”,{“_value”:[ ],“_isCollection”:false,“_dataType”:“STRING”,“_label”:“__undefined_”}]]}]]}},“_userId”:“005xx000001X7QL”,“_flowVersionId”:“301xx000003GYlP”,“_flowDevName”:“datacaptureFlow1”,“arguments”:{“_map__”:[ ]},“_visitedScreenFieldTemplates”:{“_map_”:[ ]},“_interviewStartTime”:“2 024-07-26T22:35:22.605Z”}’
   After obtaining the JSON data characterizing the current state of the offline execution of the flow, the flow engine service 102 encodes (e.g., using Base64) and serializes the foregoing JSON data to convert the offline flow execution data from a JSON representation into the following serialized representation:
e+KAnF9jdXJyZW50Tm9kZU5hbWXigJ064oCcc2NyZWVuMSIs4oCcX2lzQ3VycmVudE5vZGVJbnRlcmFjdGl2ZeKAnTpmYWxzZSzigJxfcGF 1c2VkRmxvd 0ludGVydmlld0lk4oCdOuKAnF9fdW5kZWZpbmVkX1/igJws4oCdX2ludGVyd mlld0pvdXJuYWxMaXN04oCdOlt74oCcX3RpbWVzdGFtcOKAnTrigJwyMDI 0LTA3LTI2VDIyOjM1OjIyLjYwNlrigJ0s4oCcX2N1cnJlbnROb2RlTmFtZeKA nTrigJxfMCIs4oCcX2NoYW5nZWRWYWx1ZU1hcOKAnTp74oCcX19tYXBf X+KAnDpbW+KAnHBhcmVudE9iamVjdFR5cGXigJ0se+KAnF92YWx1ZeKA nTpbXSzigJxfaXNDb2xsZWNOaW9u4oCdOmZhbHNlLOKAnF9kYXRhVHlw ZeKAnTrigJxTVFJJTkfigJ0 s4oCcX2xhYmVs4oCdOuKAnF9fdW5kZWZpbmV kX1/igJx9XSxb4oCccGFyZW50UmVjb3JkSWTigJOse+KAnF92YWx1ZeKAnT pbXSzigJxfaXNDb2xsZWNOaW9u4oCdOmZhbHNlLOKAnF9kYXRhVHlwZe KAnTrigJxTVFJJTkfigJ0 s4oCcX2xhYmVs4oCdOuKAnF9fdW5kZWZpbmVkX 1/igJx9XSxb4oCccmVjb3JkSWTigJ0se+KAnF92YWx1ZeKAnTpbXSzigJxfaX NDb2xsZWNOaW9u4oCdOmZhbHNlLOKAnF9kYXRhVHlwZeKAnTrigJxTV FJJTkfigJ0 s4oCcX2xhYmVs4oCdOuKAnF9fdW5kZWZpbmVkX1/igJx9XV19 LOKAnF9qb3VybmFsSXRlbVR5cGXigJ064oCcU1RBUlTigJ0 s4oCcX21lc3Nh Z2XigJ064oCc4oCdLOKAnF91c2VySWTigJ064oCcMDA1eHgwMDAwMDF YN1FM4oCdLOKAnF9pcON1cnJlbnROb2RlSW50ZXJhY3RpdmXigJ06ZmFsc 2V9XSzigJxfbG9jYXRpb25TdGFja+KAnTpbe+KAnF9qb3VybmFsSXRlbVR5c GXigJ064oCcU1RBUlTigJ0 s4oCcX2N1cnJIbnROb2RlTmFtZeKAnTrigJxfMCI s4oCcX2lzTm9kZUludGVyYWNOaXZl4oCdOmZhbHNlLOKAnF9jaGFuZ2Vk VmFsdWVNYXDigJ06e+KAnF9fbWFwX1/igJw6W1vigJxwYXJlbnRPYmplY3 RUeXB14oCdLHvigJxfdmFsdWXigJ06W10s4oCcX2lzQ29sbGVjdGlvbuKAnT pmYWxzZSzigJxfZGF0YVR5cGXigJ064oCcU1RSSU5H4oCdLOKAnF9sYWJ lbOKAnTrigJxfX3VuZGVmaW51ZF9f4oCcfV0sW+KAnHBhcmVudFJlY29yZ Elk4oCdLHvigJxfdmFsdWXigJ06W10s4oCcX21zQ29sbGVjdGlvbuKAnTpmY WxzZSzigJxfZGF0YVR5cGXigJ064oCcU1RSSU5H4oCdLOKAnF9sYWJlbOK AnTrigJxfX3VuZGVmaW51ZF9f4oCcfV0sW+KAnHJlY29yZElk4oCdLHvigJxf dmFsdWXigJ06W1Os4oCcX2lzQ29sbGVjdGlvbuKAnTpmYWxzZSzigJxfZGF0 YVR5cGXigJ064oCcU1RSSU5H4oCdLOKAnF9sYWJlbOKAnTrigJxfX3VuZ GVmaW51ZF9f4oCcfV1dfX1dLOKAnF9pbnRlcnZpZXdTdGFOZeKAnTp74oC cX3VuY29tbW10dGVkVmFsdWVNYXDigJ06e+KAnF9fbWFwX1/igJw6W1vi gJxzaG9ydHRleHTigJ0se+KAnF92YWx1ZeKAnTpbe+KAnF9fbWFwX1/igJw6 W1vigJx2YWx1ZeKAnSx74oCcX3ZhbHV14oCdOlvigJxIZXJ1IG1zIHNvbWUg dmFsdWXigJ1dLOKAnF9pcONvbGxlY3Rpb27igJ06ZmFsc2Us4oCcX2RhdGF UeXB14oCdOuKAnFNUUk1OR+KAnSzigJxfbGFiZWzigJ064oCcX191bmR1Zm luZWRfX+KAnH1dXX1dLOKAnF9pcONvbGxlY3Rpb27igJ06ZmFsc2Us4oCc X2RhdGFUeXB14oCdOuKAnExJROhUTk1OR19DT01QT05FT1RfT1VUUFVU 4oCdLOKAnF9sYWJ1bOKAnTrigJxfX3VuZGVmaW51ZF9f4oCcfV1dfSzigJxfd mFsdWVNYXDigJ06e+KAnF9fbWFwX1/igJw6W1vigJxwYXJlbnRPYmplY3R UeXB14oCdLHvigJxfdmFsdWXigJ06W1Os4oCcX2lzQ29sbGVjdGlvbuKAnTp mYWxzZSzigJxfZGF0YVR5cGXigJ064oCcU1RSSU5H4oCdLOKAnF9sYWJ1 bOKAnTrigJxfX3VuZGVmaW51ZF9f4oCcfV0sW+KAnHBhcmVudFJ1Y29yZE lk4oCdLHvigJxfdmFsdWXigJ06W10s4oCcX2lzQ29sbGVjdGlvbuKAnTpmYW xzZSzigJxfZGF0YVR5cGXigJ064oCcU1RSSU5H4oCdLOKAnF9sYWJ1bOKA nTrigJxfX3VuZGVmaW51ZF9f4oCcfV0sW+KAnHJlY29yZElk4oCdLHvigJxfd mFsdWXigJ06W10s4oCcX2lzQ29sbGVjdGlvbuKAnTpmYWxzZSzigJxfZGF0 YVR5cGXigJ064oCcU1RSSU5H4oCdLOKAnF9sYWJ1bOKAnTrigJxfX3VuZ GVmaW51ZF9f4oCcfV1dfSzigJxfZWxlbWVudDJIaXNOb3J5TWFw4oCdOnvig JxfX21hcF9f4oCcOltb4oCcXzDigJ0se+KAnF9fbWFwX1/igJw6W1vigJxwYXJ1 bnRPYmplY3RUeXB14oCdLHvigJxfdmFsdWXigJ06W10s4oCcX2lzQ29sbGVj dGlvbuKAnTpmYWxzZSzigJxfZGF0YVR5cGXigJ064oCcU1RSSU5H4oCdLO KAnF9sYWJ1bOKAnTrigJxfX3VuZGVmaW51ZF9f4oCcfV0sW+KAnHBhcmV udFJlY29yZElk4oCdLHvigJxfdmFsdWXigJ06W1Os4oCcX2lzQ29sbGVjdGlvbu KAnTpmYWxzZSzigJxfZGF0YVR5cGXigJ064oCcU1RSSU5H4oCdLOKAnF9 sYWJ1bOKAnTrigJxfX3VuZGVmaW51ZF9f4oCcfV0sW+KAnHJ1Y29yZElk4o CdLHvigJxfdmFsdWXigJ06W10s4oCcX2lzQ29sbGVjdGlvbuKAnTpmYWxzZ SzigJxfZGF0YVR5cGXigJ064oCcU1RSSU5H4oCdLOKAnF9sYWJ1bOKAnTri gJxfX3VuZGVmaW51ZF9f4oCcfV1dfV1dfXOs4oCcX3VzZXJJZOKAnTrigJww MDV4eDAwMDAwMVg3UUzigJ0 s4oCcX2Zsb3dWZXJzaW9uSWTigJ064oCc MzAxeHgwMDAwMDNHWWxQ4oCdLOKAnF9mbG93RGV2TmFtZeKAnTri gJxkYXRhY2FwdHVyZUZsb3cxIizigJxfYXJndW1lbnRz4oCdOnvigJxfX21hcF 9f4oCcOltdfSzigJxfdmlzaXRIZFNjcmVlbkZpZWxkVGVtcGxhdGVz4oCdOnvi gJxfX21hcF9f4oCcOltdfSzigJxfaW50ZXJ2aWV3U3RhcnRUaW114oCdOuKAn DIwMjQtMDctMjZUMjI6MzU6MjIuNjA1WuKAnX0=

Still referring to FIG. 5, 5n exemplary implementations, after serializing the uncommitted values and other local object data characterizing the current state of the offline execution of the flow, the offline flow pausing process 500 continues by automatically encrypting the serialized flow execution data prior to updating a serialized field of a local object for tracking the flow interactions to include the encrypted serialized flow execution data (tasks 510, 512). In this regard, the serialized flow execution data is encrypted using an encryption key or cryptographic function known to the application platform 140 and/or the database system 104 to support encrypted transmission of the data over the network 130 and subsequent decryption at the database system 104 when the offline flow execution data is uploaded to the database system 104 when the field service mobile application 106 returns to an online mode or network connectivity is otherwise restored. After encryption, in exemplary implementations, the flow engine service 102 updates a serialized view field of the flow interview object 304 to include the encrypted serialized flow execution data that maintains the uncommitted values and current state of execution of the paused offline execution of the data capture form process flow. For example, the flow engine service 102 may make an API call to the client-side data service 150 that causes the client-side data service 150 to create and/or update an instance of the flow interview object 304 associated with the paused offline execution of the data capture form process flow in the client-side data service cache having the encrypted serialized flow execution data stored in its serialized view field. Additionally, the flow engine service 102 may cause the client-side data service 150 to update a flow type field for the flow interview object 304 to indicate an offline flow type, such that once the flow interview object 304 is updated to the database system 104 for storage in the database 134, the serialized view field can be decrypted and parsed or otherwise decoded in the appropriate manner to facilitate reconstructing and resuming execution of the data capture form process flow from the paused state of offline execution (e.g., by automatically populating the GUI display that was presented at the time of pausing with the uncommitted user input values for the GUI elements at the time of pausing) while in the online mode.

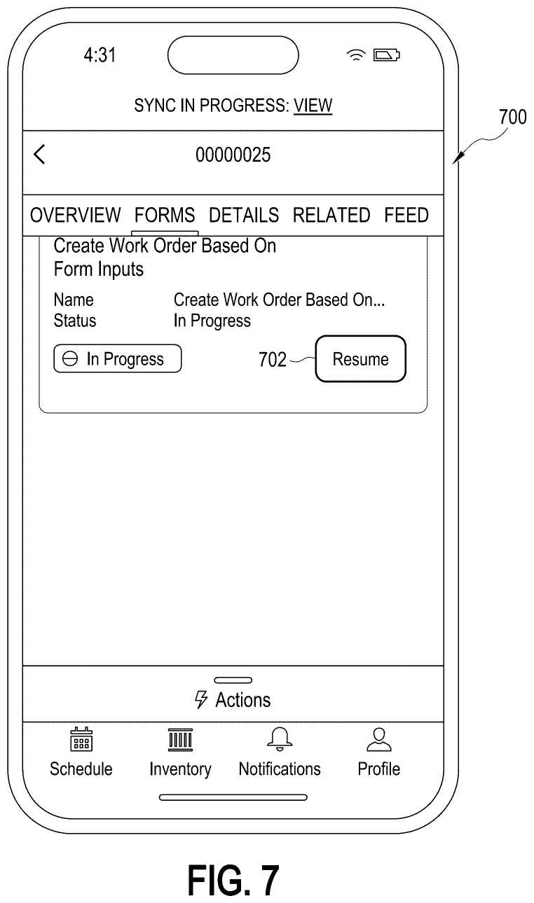

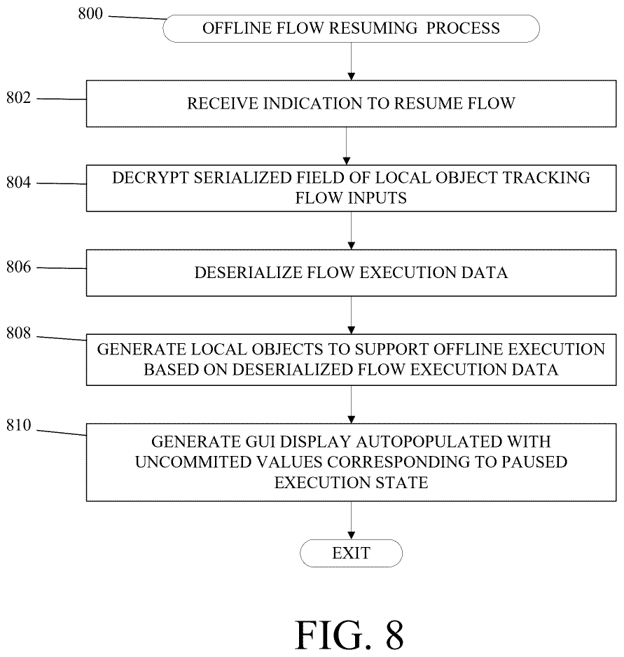

FIG. 7 depicts an updated form landing page GUI display 700 suitable for presentation by field service mobile application 106 (e.g., as a GUI display 108 on the display device 112) after performance of the offline flow pausing process 500 to pause offline execution of a data capture form process flow. As shown, the button or other selectable GUI element 702 associated with a paused data capture form may be updated to include text or other indicia that the data capture form has been paused or otherwise not completed and may be resumed for completion. Referring now to FIG. 8 with continued reference to FIGS. 1-7, in response to user selection of the GUI element 702 to resume a data capture form process flow, the flow engine service 102 automatically initiates or otherwise performs an offline flow resuming process 800 to resume execution of a paused data capture form process flow from the state of execution in which the data capture form process flow was previously paused.

FIG. 8 depicts an exemplary offline flow resuming process 800 suitable for implementation by a flow engine service associated with a native application at a mobile device to support resuming execution from a prior state of a process flow defined by custom metadata at a database system during offline execution and perform additional tasks, functions, and/or operations described herein. For illustrative purposes, the following description may refer to elements mentioned above in connection with FIGS. 1-7. It should be appreciated that the offline flow resuming process 800 may include any number of additional or alternative tasks, the tasks need not be performed in the illustrated order and/or the tasks may be performed concurrently, and/or the offline flow resuming process 800 may be incorporated into a more comprehensive procedure or process having additional functionality not described in detail herein. Moreover, one or more of the tasks shown and described in the context of FIG. 8 could be omitted from a practical implementation of the offline flow resuming process 800 as long as the intended overall functionality remains intact.

For purposes of explanation, the offline flow resuming process 800 may be described herein in the context of resuming offline execution of a flow that was previously paused during offline execution. However, it should be noted that the subject matter described herein is not limited to a flow that was paused during offline execution and may be implemented in an equivalent manner for flow that were paused during online operation. In this regard, during online operation, corresponding instances of flow interview objects for tracking interactions with the process flow during online operation may be created and maintained in a corresponding table of the database 134 at the database system 104. When the native application 106 launches or otherwise executes at the mobile device 110, the flow interview object data records and corresponding metadata 148 may be automatically downloaded to the cache associated with the client-side data service 150 as described above to prime the mobile device 110 for offline operation of any data capture form process flows associated with the resource owner, in a similar manner as described above. Thus, the offline flow resuming process 800 may be performed while in an offline mode to resume execution of a paused online flow using the primed data capture form configuration metadata 148 and downloaded record data from one or more data records 146 associated with the respective data capture form process flow.

Referring to FIG. 8, with continued reference to FIGS. 1-7, in exemplary implementations, the offline flow resuming process 800 begins in response to identifying or otherwise receiving one or more indicia to resume execution of a flow that was previously paused during execution (task 802). In response, the offline flow resuming process 800 retrieves or otherwise obtains the data or information stored in the serialized field of the local object for tracking the flow interactions and decrypts the serialized field before parsing or otherwise decoding the decrypted serialized flow execution data into the respective the key-value pairs of uncommitted user input values and associated GUI elements along with the key-value pairs of committed user input values and associated GUI elements from other GUI displays or nodes previously traversed by the user along with information characterizing the sequence of prior interactions with the data capture form process flow (tasks 804, 806). In this regard, the flow engine service 102 performs the reverse or inverse of the encoding and encryption operations of the offline flow pausing process 500 to decrypt and deserialize the serialized view field and obtain deserialized flow execution data identifying the uncommitted user input values and associated GUI elements, the key-value pairs of committed user input values and associated GUI elements, and the sequence of GUI displays or nodes previously traversed by the user.

After decrypting and deserializing the flow execution data, the offline flow resuming process 800 automatically generates or otherwise creates one or more local objects to support offline execution of the flow and then automatically generates the GUI display of the flow corresponding to the paused state of execution (tasks 808, 810). In this regard, the flow engine service 102 utilizes the key-value pairs of committed user input values and associated GUI elements and other data characterizing the sequence of GUI displays or nodes previously traversed by the user to recreate corresponding journal objects, interview state objects and/or other local JavaScript objects corresponding to the user's prior interactions with the data capture form process flow, which, in turn may be utilized to identify the particular screen node and corresponding data capture form GUI display to be presented corresponding to the paused execution state of the data capture form process flow. Additionally, the key-value pairs of uncommitted user input values and associated GUI elements may be utilized to recreate the JSON data for the identified data capture form GUI display that was the currently presented GUI display at the time of pausing the data capture form process flow such that that data capture form GUI display is automatically populated with the uncommitted user input values or other GUI element state information from the time of pausing. In this manner, the data capture form GUI display may be generated and rendered in a substantially identical state to the previously presented state of the GUI display at the time of pausing. For example, referring to FIGS. 6-7, in response to selection of the button 702 to resume a paused data capture form process flow that was paused in response to the selection of button 602, the data capture form GUI display 600 may be automatically generated with the GUI elements 610, 612, 614, 616, 618 automatically populated with the previously input user input values depicted in FIG. 6 as the flow engine service 102 navigates the field service mobile application 106 from the updated form landing page GUI display 700 directly to the data capture form GUI display 600 where the flow was previously paused without the user having to traverse any intermediary GUI displays or screen nodes.

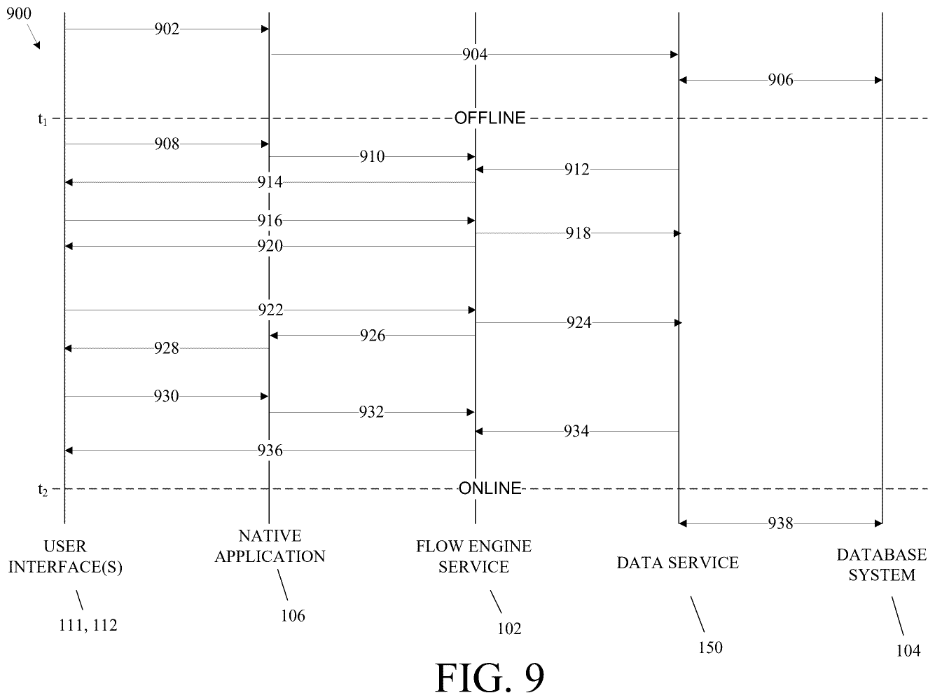

FIG. 9 depicts a timing diagram of an exemplary sequence 900 of communications within the system 100 of FIG. 1 in connection with an exemplary implementation of the offline flow pausing process 500 and the offline flow resuming process 800 in connection with the offline flow execution process 400. The illustrated sequence begins with a user of a mobile device 110 manipulating a user input device 111 to interact with the operating system of the mobile device 110 and provide 902 a corresponding user input to launch, trigger or otherwise initiate execution of a native application 106. When the native application 106 is launched, the native application 106 transmits or otherwise provides 904 a request to the client-side data service 150 that causes the client-side data service 150 to communicate 906 with the database system 104 to automatically prime the mobile device 110 for offline operation of any data capture form process flows associated with the resource owner associated with the mobile device end user. In this regard, the client-side data service 150 utilizes the application platform 140 and/or APIs 144 at the database system 104 to automatically download data capture form configuration metadata 148 and record data from other data records 146 associated with that end user and/or resource owner to local data storage at the mobile device 110, as described above in the context of FIGS. 1-4.

After a subsequent point in time (t₁), when the native application 106 has entered an offline mode (e.g., due to a loss of connectivity to the network 130), when the user manipulates the user input device 111 to provide 908 a request to initiate a data capture form process flow in the offline mode, the native application 106 automatically invokes 910 the flow engine service 910, which retrieves 912 the downloaded data capture form configuration metadata 148 via the client-side data service 150 and generates 914 a data capture form GUI display associated with the selected data capture form process flow using the downloaded data capture form configuration metadata 148.

As described above, the user may interact with the GUI elements of the data capture form GUI display in the offline mode to input or otherwise provide values for one or more fields of a data capture form data record or other data records to be maintained at the database system 104 before providing an indication to the flow engine service 102 to commit the input values and advance through the sequence of GUI displays associated with the data capture form process flow. The flow engine service 102 updates or otherwise manages the local objects to track or otherwise maintain the user's progress within the data capture form process flow, provides 918 one or more requests to the client-side data service 150 to create and/or update cached versions of the data records 146 within the cache associated with the client-side data service 150 while in the offline mode, and automatically updates 920 the data capture form GUI display to traverse through the sequence of data capture form GUI displays associated with the data capture form process flow.

As described above in the context of FIGS. 5-6, to pause the data capture form process flow, the user manipulates a user input device 111 to provide 922 an indication of a desire to pause execution of the process flow (e.g., by selecting button 602) to the flow engine service 102, which, in turn, captures the uncommitted values and other information characterizing the current state of the data capture form GUI display from which the pause is initiated, serializes and encrypts the data, and then provides a corresponding request 924 to the client-side data service 150 to update a serialized field of a flow interview record 304 in the client-side data service cache to include the encrypted serialized values characterizing the current state of the data capture form GUI display at the time of pausing. Thereafter, the flow engine service 102 provides 926 a corresponding command or instruction to the native application 106 to generate or otherwise provide 928 a landing page GUI display that reflects pausing or exiting the data capture form process flow.

As described above in the context of FIGS. 7-8, to resume the data capture form process flow, the user manipulates a user input device 111 to provide 930 an indication of a desire to resume execution of the process flow (e.g., by selecting button 702) to the native application 106, which, in turn, invokes 932 the flow engine service 102 to retrieve 934 the value of the serialized field of the flow interview object 304 in the client-side data service cache associated with the data capture form process flow. The flow engine service 102 decrypts and deserializes the retrieved value of the serialized field to regenerated the local JavaScript objects and other JSON data corresponding to the previous state of the data capture form process flow at the time of pausing and then automatically generates or otherwise updates 936 the display device 112 to depict the data capture form GUI display with the uncommitted values or other GUI element states corresponding to the respective GUI display at the time of pausing. In this manner, the user may pause and resume data capture form process flows while operating offline.

At some subsequent point in time (t₂), when the native application 106 returns to an online mode (e.g., due to a restoration of connectivity to the network 130), the client-side data service 150 automatically interacts 938 with the database system 104 to synchronize the client-side data service cache with the database system 104 by making one or more API calls to create corresponding data records 146 for the data capture forms initiated or created offline. For example, as described above, in response to exiting the offline mode, the data service 150 is configured to automatically update the database 134 at the database system 104 to reflect the user's interaction with respect to the respective data capture form process flow by providing corresponding requests for CRUD operations to one or more APIs 144 at the database system 104 create, modify or otherwise update data records 146 corresponding to the flow record object 302 and flow interview object 304 utilized to track the user's interactions and progress within a form as well as any other field service data records 146 corresponding to the local field service objects 306, 308, 310 to reflect the user's interactions with the data capture form process flow. For example, the flow engine service 102 may provide requests to the client-side data service 150 to create data capture form and flow interview records 146 in the database 134 having the desired relationships with other field services records 146 in the database 134 corresponding to the respective local objects 306, 308, 310 (e.g., the parent WorkOrder, ServiceAppointment and/or the like), with field values for the data capture form and flow interview records 146 in the database 134 being populated with user input data or other values from the local objects 302, 304 utilized to track the user's progress within the form. In this regard, the serialized field of the flow interview record 146 in the database 134 may be populated with the encrypted serialized flow execution data, with the resulting identifier for the flow interview record 146 in the database 134 being provided back to the client-side data service 150 for updating a placeholder identifier for the flow interview object 304 on the client side. The serialized field of the flow interview record 146 may then be utilized by the field service mobile application 106 in either the online or offline mode for resuming execution of the respective data capture form process flow as described herein.

By virtue of the subject matter described herein, a field service technician user of a field service mobile application 106 may initiate and progress through data capture form process flows to input information for data capture forms while in an offline mode, while also being able to pause and resume execution of data capture form process flows to switch between different data capture forms, different field service records, and/or the like without losing his or her progress or uncommitted values that were previously entered, and without having to restart a particular form, thereby saving the field service technician user's time and effort in completing the forms. Once online connectivity is restored, the offline interactions are synchronized with the database system in a manner that allows forms to be resumed online or offline.

By utilizing the serialized field of a flow interview object to maintain uncommitted user input values and other form state information, along with other local JavaScript objects or JSON data created during offline execution of the data capture form process flow, the paused flow information captures the different screens, navigations, branching logic, and/or conditional visibility at the client-side that allows for the paused data capture form process flow to be audited and reconstructed upon resume from the server-side in an online mode, as well as client-side in the offline mode. Priming the application configuration metadata and other record data by the client-side data service allows flows to be initiated offline, with user interface API calls to the client-side data service being utilized to retrieve data from the client-side data service cache using temporary or placeholder records created in the client-side data service cache. The JSON data or other local JavaScript objects used to support and track offline execution of the flow are encoded in a serialized format and encrypted prior to storing the encrypted serialized flow execution data to the client-side data service cache for security purposes so that the client-side data service can automatically synchronize the client-side data service cache with the database system in response to entering an online mode while protecting the JSON data or other local JavaScript object data being transmitted over the network.

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read-only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as services) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

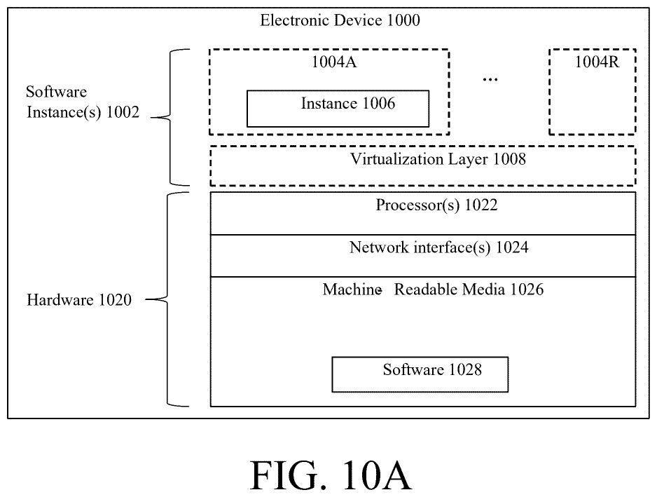

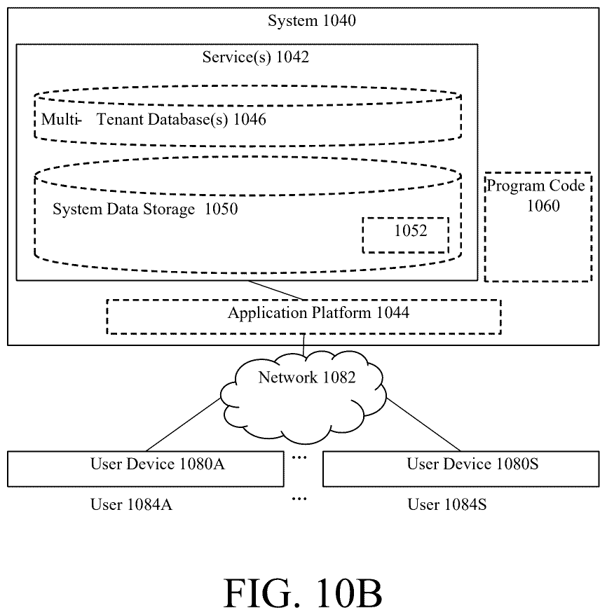

FIG. 10A is a block diagram illustrating an electronic device 1000 according to some example implementations. FIG. 10A includes hardware 1020 comprising a set of one or more processor(s) 1022, a set of one or more network interfaces 1024 (wireless and/or wired), and machine-readable media 1026 having stored therein software 1028 (which includes instructions executable by the set of one or more processor(s) 1022). The machine-readable media 1026 may include non-transitory and/or transitory machine-readable media. Each of the previously described applications and related services may be implemented in one or more electronic devices 1000. In one implementation: 1) each of the clients is implemented in a separate one of the electronic devices 1000 (e.g., in end user devices where the software 1028 represents the software to implement clients to interface directly and/or indirectly with the field service mobile application and/or flow engine service (e.g., software 1028 represents a web browser, a native client, a portal, a command-line interface, and/or an application programming interface (API) based upon protocols such as Simple Object Access Protocol (SOAP), Representational State Transfer (REST), etc.)); 2) the field service mobile application and/or flow engine service is implemented in a separate set of one or more of the electronic devices 1000 (e.g., a set of one or more server devices where the software 1028 represents the software to implement the field service mobile application and/or flow engine service); and 3) in operation, the electronic devices implementing the clients and the field service mobile application and/or flow engine service would be communicatively coupled (e.g., by a network) and would establish between them (or through one or more other layers and/or or other services) connections for submitting requests to the field service mobile application and/or flow engine service. Other configurations of electronic devices may be used in other implementations (e.g., an implementation in which the client and the field service mobile application and/or flow engine service are implemented on a single one of electronic device 1000).

During operation, an instance of the software 1028 (illustrated as instance 1006 and referred to as a software instance; and in the more specific case of an application, as an application instance) is executed. In electronic devices that use compute virtualization, the set of one or more processor(s) 1022 typically execute software to instantiate a virtualization layer 1008 and one or more software container(s) 1004A-1904R (e.g., with operating system-level virtualization, the virtualization layer 1008 may represent a container engine (such as Docker Engine by Docker, Inc. or rkt in Container Linux by Red Hat, Inc.) running on top of (or integrated into) an operating system, and it allows for the creation of multiple software containers 1004A-1904R (representing separate user space instances and also called virtualization engines, virtual private servers, or jails) that may each be used to execute a set of one or more applications; with full virtualization, the virtualization layer 1008 represents a hypervisor (sometimes referred to as a virtual machine monitor (VMM)) or a hypervisor executing on top of a host operating system, and the software containers 1004A-1904R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 1028 is executed within the software container 1004A on the virtualization layer 1008. In electronic devices where compute virtualization is not used, the instance 1006 on top of a host operating system is executed on the “bare metal” electronic device 1000. The instantiation of the instance 1006, as well as the virtualization layer 1008 and software containers 1004A-1904R if implemented, are collectively referred to as software instance(s) 1002.

Alternative implementations of an electronic device may have numerous variations from that described above. For example, customized hardware and/or accelerators might also be used in an electronic device.

FIG. 10B is a block diagram of a deployment environment according to some example implementations. A system 1040 includes hardware (e.g., a set of one or more server devices) and software to provide service(s) 1042, including one or more services configurable to support a field service mobile application and/or a flow engine service. In some implementations the system 1040 is in one or more datacenter(s). These datacenter(s) may be: 1) first party datacenter(s), which are datacenter(s) owned and/or operated by the same entity that provides and/or operates some or all of the software that provides the service(s) 1042; and/or 2) third-party datacenter(s), which are datacenter(s) owned and/or operated by one or more different entities than the entity that provides the service(s) 1042 (e.g., the different entities may host some or all of the software provided and/or operated by the entity that provides the service(s) 1042). For example, third-party datacenters may be owned and/or operated by entities providing public cloud services (e.g., Amazon.com, Inc. (Amazon Web Services), Google LLC (Google Cloud Platform), Microsoft Corporation (Azure)).

The system 1040 is coupled to user devices 1080A-1980S over a network 1082. The service(s) 1042 may be on-demand services that are made available to one or more of the users 1084A-1984S working for one or more entities other than the entity which owns and/or operates the on-demand services (those users sometimes referred to as outside users) so that those entities need not be concerned with building and/or maintaining a system, but instead may make use of the service(s) 1042 when needed (e.g., when needed by the users 1084A-1984S). The service(s) 1042 may communicate with each other and/or with one or more of the user devices 1080A-1980S via one or more APIs (e.g., a REST API). In some implementations, the user devices 1080A-1980S are operated by users 1084A-1984S, and each may be operated as a client device and/or a server device. In some implementations, one or more of the user devices 1080A-1980S are separate ones of the electronic device 1000 or include one or more features of the electronic device 1000.

In some implementations, the system 1040 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants. In one implementation, the system 1040 is a multi-tenant cloud computing architecture supporting multiple services, such as one or more of the following types of services: Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Authorization; Authentication; Security; and Identity and access management (IAM). For example, system 1040 may include an application platform 1044 that enables PAAS for creating, managing, and executing one or more applications developed by the provider of the application platform 1044, users accessing the system 1040 via one or more of user devices 1080A-1980S, or third-party application developers accessing the system 1040 via one or more of user devices 1080A-1980S.

In some implementations, one or more of the service(s) 1042 may use one or more multi-tenant databases 1046, as well as system data storage 1050 for system data 1052 accessible to system 1040. In certain implementations, the system 1040 includes a set of one or more servers that are running on server electronic devices and that are configured to handle requests for any authorized user associated with any tenant (there is no server affinity for a user and/or tenant to a specific server). The user devices 1080A-1980S communicate with the server(s) of system 1040 to request and update tenant-level data and system-level data hosted by system 1040, and in response the system 1040 (e.g., one or more servers in system 1040) automatically may generate one or more Structured Query Language (SQL) statements (e.g., one or more SQL queries) that are designed to access the desired information from the multi-tenant database(s) 1046 and/or system data storage 1050.

In some implementations, the service(s) 1042 are implemented using virtual applications dynamically created at run time responsive to queries from the user devices 1080A-1980S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 1062 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others.

Further, in one implementation, the application platform 1044 includes an application setup mechanism that supports application developers' creation and management of applications, which may be saved as metadata by save routines. Invocations to such applications, including by the field service mobile application and/or flow engine service, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 1082 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a third Generation Partnership Project (3GPP) protocol, a fourth generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 1040 and the user devices 1080A-1980S.

Each user device 1080A-1980S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 1040. For example, the user interface device can be used to access data and applications hosted by system 1040, and to perform searches on stored data, and otherwise allow one or more of users 1084A-1984S to interact with various GUI pages that may be presented to the one or more of users 1084A-1984S. User devices 1080A-1980S might communicate with system 1040 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 1080A-19805 might include an HTTP client, commonly referred to as a “browser,” for sending and receiving HTTP messages to and from server(s) of system 1040, thus allowing users 1084A-19845 of the user devices 1080A-19805 to access, process and view information, pages and applications available to it from system 1040 over network 1082.

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting. Accordingly, details of the exemplary implementations described above should not be read into the claims absent a clear intention to the contrary.

What is claimed is:

1. A method of supporting offline operation of a native application at a client device, the method comprising:
providing a graphical user interface (GUI) display associated with the native application at the client device, the GUI display comprising a selectable GUI element for a flow associated with a record at a database system coupled to a communications network;
in response to selection of the selectable GUI element, generating a second GUI display associated with the flow;
receiving, at the client device via one or more GUI elements of the second GUI display associated with the flow, input information for one or more fields for a form associated with the flow;
in response to an indication to pause the flow while in an offline mode:
capturing current values for the input information at the client device from the second GUI display;
encoding the current values in a serialized format, resulting in serialized encoded values; and
updating a field of an object associated with the record and the flow in a data storage at the client device to include the serialized encoded values; and
in response to a subsequent indication to resume the flow associated with the record, regenerating the second GUI display associated with the flow using the serialized encoded values from the field of the object to populate the one or more GUI elements.

2. The method of claim 1, further comprising automatically initiating, by a data service at the client device, creation of a second record corresponding to the object at the database system in response to entering an online mode, wherein the second record at the database system comprises the field comprising the serialized encoded values.

3. The method of claim 1, wherein:
capturing the current values for the input information comprises capturing JSON data corresponding to a state of the second GUI display at a time associated with the indication to pause the flow, the JSON data maintaining an association between a respective uncommitted user input value and a respective GUI element of the second GUI display; and
encoding the current values comprises serializing the JSON data to obtain the serialized encoded values.

4. The method of claim 3, further comprising capturing one or more JavaScript objects associated with one or more preceding GUI displays associated with the flow, wherein encoding the current values comprises serializing the JSON data and the one or more JavaScript objects to obtain the serialized encoded values.

5. The method of claim 4, further comprising encrypting the serialized encoded values, resulting in encrypted serialized flow execution data, wherein updating the field comprises updating a serialized field of the object to include the encrypted serialized flow execution data.

6. The method of claim 5, wherein regenerating the second GUI display comprises:
decrypting the encrypted serialized flow execution data of the serialized field of the object to obtain serialized flow execution data;
deserializing the serialized flow execution data to obtain the JSON data and the one or more JavaScript objects; and
generating the second GUI display using the JSON data to automatically populate the respective GUI element of the second GUI display with the respective uncommitted user input value.

7. The method of claim 1, further comprising downloading flow configuration metadata from the database system to the data storage at the client device prior to entering the offline mode, wherein generating the second GUI display associated with the flow comprises generating the second GUI display using the downloaded flow configuration metadata.

8. The method of claim 1, wherein:
the native application comprises a field service mobile application;
the flow comprises a data capture form process flow;
the record comprises one of a work order, a service appointment, or a work order line item;
the object comprises a flow interview object maintaining an association between the record and a data capture junction object associated with the data capture form process flow; and
the field comprises a serialized field of the flow interview object.

9. A non-transitory machine-readable storage medium that provides instructions that, when executed by a processor, are configurable to cause the processor to perform operations comprising:
providing a graphical user interface (GUI) display associated with a native application at a client device, the GUI display comprising a selectable GUI element for a flow associated with a record at a database system;
in response to selection of the selectable GUI element, generating a second GUI display associated with the flow;
receiving, at the client device via one or more GUI elements of the second GUI display associated with the flow, input information for one or more fields for a form associated with the flow;
in response to an indication to pause the flow while in an offline mode:
capturing current values for the input information at the client device from the second GUI display;
encoding the current values in a serialized format, resulting in serialized encoded values; and
updating a field of an object associated with the record and the flow in a data storage at the client device to include the serialized encoded values; and
in response to a subsequent indication to resume the flow associated with the record, regenerating the second GUI display associated with the flow using the serialized encoded values from the field of the object to populate the one or more GUI elements.

10. The non-transitory machine-readable storage medium of claim 9, wherein the instructions are configurable to cause the processor to automatically initiate, using a data service at the client device, creation of a second record corresponding to the object at the database system in response to entering an online mode, wherein the second record at the database system comprises the field comprising the serialized encoded values.

11. The non-transitory machine-readable storage medium of claim 9, wherein the instructions are configurable to cause the processor to:
capture JSON data corresponding to a state of the second GUI display at a time associated with the indication to pause the flow, the JSON data maintaining an association between a respective uncommitted user input value and a respective GUI element of the second GUI display; and
serialize the JSON data to obtain the serialized encoded values.

12. The non-transitory machine-readable storage medium of claim 11, wherein the instructions are configurable to cause the processor to capture one or more JavaScript objects associated with one or more preceding GUI displays associated with the flow, wherein encoding the current values comprises serializing the JSON data and the one or more JavaScript objects to obtain the serialized encoded values.

13. The non-transitory machine-readable storage medium of claim 12, wherein the instructions are configurable to cause the processor to encrypt the serialized encoded values, resulting in encrypted serialized flow execution data, wherein updating the field comprises updating a serialized field of the object to include the encrypted serialized flow execution data.

14. The non-transitory machine-readable storage medium of claim 13, wherein the instructions are configurable to cause the processor to regenerate the second GUI display by:
decrypting the encrypted serialized flow execution data of the serialized field of the object to obtain serialized flow execution data;
deserializing the serialized flow execution data to obtain the JSON data and the one or more JavaScript objects; and
generating the second GUI display using the JSON data to automatically populate the respective GUI element of the second GUI display with the respective uncommitted user input value.

15. The non-transitory machine-readable storage medium of claim 9, wherein the instructions are configurable to cause the processor to download flow configuration metadata from the database system to the data storage at the client device prior to entering the offline mode, wherein generating the second GUI display associated with the flow comprises generating the second GUI display using the downloaded flow configuration metadata.

16. The non-transitory machine-readable storage medium of claim 9, wherein the native application comprises a field service mobile application.

17. The non-transitory machine-readable storage medium of claim 16, wherein the flow comprises a data capture form process flow.

18. The non-transitory machine-readable storage medium of claim 17, wherein:
the record comprises one of a work order, a service appointment, or a work order line item;
the object comprises a flow interview object maintaining an association between the record and a data capture junction object associated with the data capture form process flow; and
the field comprises a serialized field of the flow interview object.

19. A computing device comprising:
at least one non-transitory machine-readable storage medium that stores software for a native application including a flow engine service and a client-side data service; and
at least one processor, coupled to the at least one non-transitory machine-readable storage medium, to execute the software that implements the native application and the flow engine service and that is configurable to:
provide a graphical user interface (GUI) display associated with the native application, the GUI display comprising a selectable GUI element for a flow associated with a record at a database system;
in response to selection of the selectable GUI element, generating a second GUI display associated with the flow;
receive via one or more GUI elements of the second GUI display associated with the flow, input information for one or more fields for a form associated with the flow;
in response to an indication to pause the flow while in an offline mode:
capture, by the flow engine service, current values for the input information from the second GUI display;
encode, by the flow engine service, the current values in a serialized format, resulting in serialized encoded values; and
update, by the flow engine service using the client-side data service, a field of an object associated with the record and the flow to include the serialized encoded values; and
in response to a subsequent indication to resume the flow associated with the record, regenerating, by the flow engine service, the second GUI display associated with the flow using the serialized encoded values from the field of the object to populate the one or more GUI elements.

20. The computing device of claim 19, wherein:
the native application comprises a field service mobile application;
the flow comprises a data capture form process flow;
the record comprises one of a work order, a service appointment, or a work order line item;
the object comprises a flow interview object maintaining an association between the record and a data capture junction object associated with the data capture form process flow; and
the field comprises a serialized field of the flow interview object.
